(19) United States
(12) Patent Application Publication
(10) Pub. No.: US 2024/0095629 A1
(43) Pub. Date: Mar. 21, 2024

(54) SOURCING SUPPORT SYSTEM AND SOURCING SUPPORT METHOD

(71) Applicant: Hitachi, Ltd., Tokyo (JP)

(72) Inventors: Teppei INOUE, Tokyo (JP); Tazu Nomoto, Tokyo (JP); Keiichi Bamoto, Tokyo (JP); Yasuo Bakke, Tokyo (JP)

(73) Assignee: Hitachi, Ltd., Tokyo (JP)

(21) Appl. No.: 18/181,740

(22) Filed: Mar. 10, 2023

(30) Foreign Application Priority Data
Sep. 21, 2022 (JP) 2022-150283

(51) Int. Cl. G06Q 10/0631

(52) U.S. Cl. CPC G06Q 10/06315

(57) ABSTRACT

A sourcing support system comprises: a weight calculation unit configured to calculate the name of the related parts group related to the target part when target part specifying information is input; calculate the name of the related parts group; and calculate the evaluation index weights of the evaluation indexes of the supply capacity; and a score calculation unit configured to calculate a name of a candidate supplier who can purchase the target part; calculate the evaluation index score of the evaluation index of supply capacity and the evaluation index of soundness for the calculated names of the candidate suppliers; calculate the sum of the products of the evaluation index weight and the evaluation index score, with respect to the evaluation index of supply capacity as a supply capacity score; calculate the sum of the evaluation index score S of the evaluation index of soundness as the soundness score.

### BACKGROUND OF THE INVENTION

### 1. Field of the Invention

The present invention relates to a sourcing support system calculating a value for evaluating a supplier of parts, and a sourcing support method.

### 2. Description of the Related Art

In recent years, due to changes in social circumstances, there have been cases in which the ability of suppliers to supply parts has changed, resulting in the need to change suppliers. In order to determine the suppliers of parts, suppliers have been evaluated. Therefore, there are technologies for evaluating suppliers. For example, in JP 2013-140567 A describes a supplier evaluation method that includes, for example, an evaluation of the supplier's part manufacturing method and an evaluation of the supplier's management method for part manufacturing such as “Are workplaces organized, organized and cleaned according to the products being manufactured?”.

### SUMMARY OF THE INVENTION

However, in the technology described in JP 2013-140567 A, a supplier is evaluated by using information that can be easily known only by the person who manufactures the part at the supplier such as “Are workplaces organized, organized and cleaned according to the products being manufactured?”. Therefore, even if the technique described in JP 2013-140567 A is used, it is difficult to evaluate the supplier.

In recent years, it is sometimes necessary to change suppliers of parts due to changes in social circumstances or natural disasters. For example, the supplier that have supplied parts to date, may not be able to supply power semiconductors, which are manufactured by only 10 suppliers worldwide, due to typhoon damage. In this case, there is a possibility that the power supply semiconductor will be in short supply all over the world. If the power supply semiconductor cannot be supplied, a product using the power supply semiconductor cannot be manufactured, and there are cases where good parts cannot be supplied from good suppliers unless transactions are started with alternative suppliers.

As described above, in the case where it is necessary to promptly evaluate a plurality of suppliers and determine a supplier, the following problem arises.

1. There are many kinds of evaluation indexes for evaluating suppliers. It is not easy to evaluate all suppliers quickly because it takes time and effort to evaluate all suppliers with all evaluation indexes.

2. It is not easy to evaluate suppliers properly because evaluation standards for suppliers differ from person to person. In many cases, both manufacturing personnel and purchasing personnel evaluate suppliers. In many cases, the purchasing personnel has information on the various suppliers for the components of the various products. On the other hand, the information of the supplier possessed by the manufacturing personnel in charge of manufacturing may be limited to the information about the supplier who can purchase the parts handled by the person in charge. Therefore, the evaluation of the supplier may differ between manufacturing personnel and purchasing personnel. In addition, for example, there is a case where the evaluation of the sample obtained from the supplier differs between the manufacturing personnel who has a lot of knowledge about the function of the part and the purchasing personnel.

Therefore, it is difficult to evaluate suppliers and determine suitable suppliers. For example, a manufacturing personnel may spend time and effort to select a supplier from among a plurality of suppliers, and a purchasing personnel may determine that the supplier is inappropriate, so that an alternative supplier cannot be determined.

Therefore, an object of the present invention is to provide a sourcing support system and sourcing support method, for facilitating the selection of a suitable supplier for the part.

In order to attain the object described above, one aspect of a sourcing support system of the invention is a sourcing support system calculating a value for evaluating a supplier of parts, the sourcing support system comprising: a weight calculation unit configured to calculate the name of the related parts group related to the target part, when a target part specifying information that can specify the target part is input; calculate the name of the related parts group related to the target part; calculate the evaluation index weights of each of the evaluation indexes of the supply capacity, based on the current evaluation values of each evaluation index of supply capacity for the supplying supplier that has supplied each of the target part and the related part included in the related parts group; and a score calculation unit configured to calculate a name of a candidate supplier who can purchase the target part; calculate the evaluation index score of each of the evaluation index of supply capacity and the evaluation index score of each of the evaluation index of soundness, for each of the calculated names of the candidate suppliers; calculate the sum of the products of the evaluation index weight and the evaluation index score, with respect to the evaluation index of supply capacity as a supply capacity score; calculate the sum of the evaluation index score S of each of the evaluation index of soundness as the soundness score.

In addition, one aspect a sourcing support method of a sourcing support system of the invention is a sourcing support method of a sourcing support system wherein the sourcing support system comprising a processor, the method comprising: by the processor, a weight calculation processing configured to calculate the name of the related parts group related to the target part, when a target part specifying information that can specify the target part is input; calculate the name of the related parts group related to the target part; calculate the evaluation index weights of each of the evaluation indexes of the supply capacity, based on the current evaluation values of each evaluation index of supply capacity for the supplying supplier that has supplied each of the target part and the related part included in the related parts group; and a score calculation processing configured to calculate a name of a candidate supplier who can purchase the target part; calculate the evaluation index score of each of the evaluation index of supply capacity and the evaluation index score of each of the evaluation index of soundness, for each of the calculated names of the candidate suppliers; calculate the sum of the products of the evaluation index weight and the evaluation index score, with respect to the evaluation index of supply capacity as a supply capacity score; calculate the sum of the evaluation index score S of each of the evaluation index of soundness as the soundness score.

According to the invention, it is possible to facilitate the selection of a suitable supplier for the part.

Objects, configurations, and effects other than those described above will be obvious by the following description of Example.

### BRIEF DESCRIPTION OF THE DRAWINGS

FIG. 1 is a diagram showing an example of a function block diagram of a sourcing support system according to the embodiment;

FIG. 2 is a block diagram showing an example of a hardware configuration of the sourcing support system according to the embodiment;

FIG. 3 is a diagram showing a table showing an example of the evaluation indexes and the evaluation items of the evaluation indexes, used to calculate the supply capacity score and the soundness score;

FIG. 4 is a diagram showing an example of equations used for calculating a supply capacity score and a soundness score;

FIG. 5 is an explanatory diagram for explaining the calculation method of the evaluation index weight Wi, evaluation value weight Wij, evaluation index score Si, and evaluation value score Sij;

FIG. 6 is a diagram showing an example of the data configuration of the related component group table 101;

FIG. 7 is a diagram showing an example of the data configuration of the related parts group configuration table 102;

FIG. 8 is a diagram showing an example of the data configuration of the parts supply status table 103;

FIG. 9 is a diagram showing an example of the data configuration of the weight calculation table 104;

FIG. 10 is a diagram showing an example of the data configuration of the supplier information table 105;

FIG. 11 is a diagram showing an example of the data configuration of the quality information table 106;

FIG. 12 is a diagram showing an example of the data configuration of the quality standard information table 107;

FIG. 13 is a diagram showing an example of the data configuration of the cost information table 108;

FIG. 14 is a diagram showing an example of the data configuration of the due date information table 109;

FIG. 15 is a diagram showing an example of the data configuration of the environment information table 110;

FIG. 16 is a diagram showing an example of the data configuration of the environmental regulation information table 111;

FIG. 17 is a diagram showing an example of the data configuration of the financial information table 112;

FIG. 18 is a diagram showing an example of the data configuration of the social risk information table 113;

FIG. 19 is a diagram showing an example of the data configuration of the governance information table 114;

FIG. 20 is a diagram showing an example of the data configuration of the score calculation table 115;

FIG. 21 is a diagram showing an example of the data configuration of the weight calculation history table 116;

FIG. 22 is a diagram showing an example of the data configuration of the score calculation history table 117;

FIG. 23 is an explanatory diagram showing an example of ainput/output screen according to the embodiment;

FIG. 24 is a flowchart showing an example of a weight calculation processing of the embodiment;

FIG. 25 is a graph for explaining the relationship between the values of the evaluation value weight Wij or the evaluation value weight Wi, and the ranking of the current evaluation value of the target part;

FIG. 26 is a flowchart showing an example of a score calculation processing of the embodiment;

FIG. 27 is a graph showing the relationship between the ranking of the evaluation values of the candidate suppliers and the evaluation value score Sij of the supply capacity;

FIG. 28 is an explanatory diagram showing an example of a FSG sufficient supplier display screen showing a soundness sufficient suppliers table; and

FIG. 29 is an explanatory diagram for explaining a method of calculating the supply capacity score Sa and the soundness score Sh of the modification.

### DETAILED DESCRIPTION

Hereinafter, Example of the invention will be described with reference to the drawings. However, the present invention should not be construed as being limited to the description of the following examples. It is easily understood by those skilled in the art that the specific configuration can be modified without departing from the spirit and scope of the present invention.

In the configuration of the invention described below, the same or similar configurations or functions are denoted by the same reference numerals, and redundant description will be omitted.

In this specification and the like, expressions such as “first”, “second”, and “third” are used to identify components, and do not necessarily limit the number or order of components.

Herein, in this specification and the like, an expression “XX table” may be used as an example of various types of information, but the information may be expressed by a data structure such as an “XX list” or an “XX queue.” When describing the identification information, expressions such as “identification information”, “identifier”, “name”, “ID”, and “number” are used, but these can be replaced with each other.

In the examples of this specification, processing performed by executing a program may be described. Here, the computer executes a program by means of a processor (CPU, GPU, for example), and performs processing determined by the program while using storage resources (for example, memory), interface devices (for example, communication ports), or the like. Therefore, the subject of the processing performed by executing the program may be the processor. Similarly, the subject of the processing performed by executing the program may be a controller, a device, a system, a calculator, or a node including the processor. The subject of the processing performed by executing the program may be an operation unit, or may include a dedicated circuit performing specific processing. Here, the dedicated circuit, for example, is a field programmable gate array (FPGA), an application specific integrated circuit (ASIC), a complex programmable logic device (CPLD), or the like.

A program may be installed on a computer from a program source. The program source may be, for example, a program distribution server or a storage medium readable by a computer. When the program source is a program distribution server, the program distribution server may include a processor and a storage resource that stores a program to be distributed, and the processor of the program distribution server may distribute the program to be distributed to another computer. Further, two or more programs may be implemented as one program, or one program may be implemented as two or more programs.

### Embodiment

As described in detail below, when the name of the part of the target for which the supplier is to be examined (hereinafter referred to as a “target part”) is input, the sourcing support system 1 of the embodiment calculates a candidate supplier of a target part (hereinafter referred to as a “candidate supplier”). For each candidate supplier, the sourcing support system 1 calculates a supply capacity score Sa which is a numerical value representing supply capacity, and a soundness score Sh which is a numerical value representing soundness, from the evaluation values for various evaluation indexes.

The sourcing support system 1 associates the name of the candidate supplier, the supply capacity score Sa, and the soundness score Sh, and presents them to the user. Accordingly, the user can select the supplier of the target part by referring to the supply capacity score Sa and the soundness score Sh presented to the user by the sourcing support system 1. This makes it easy for the user to select a suitable supplier.

### <<Configuration of the Sourcing Support System 1>>

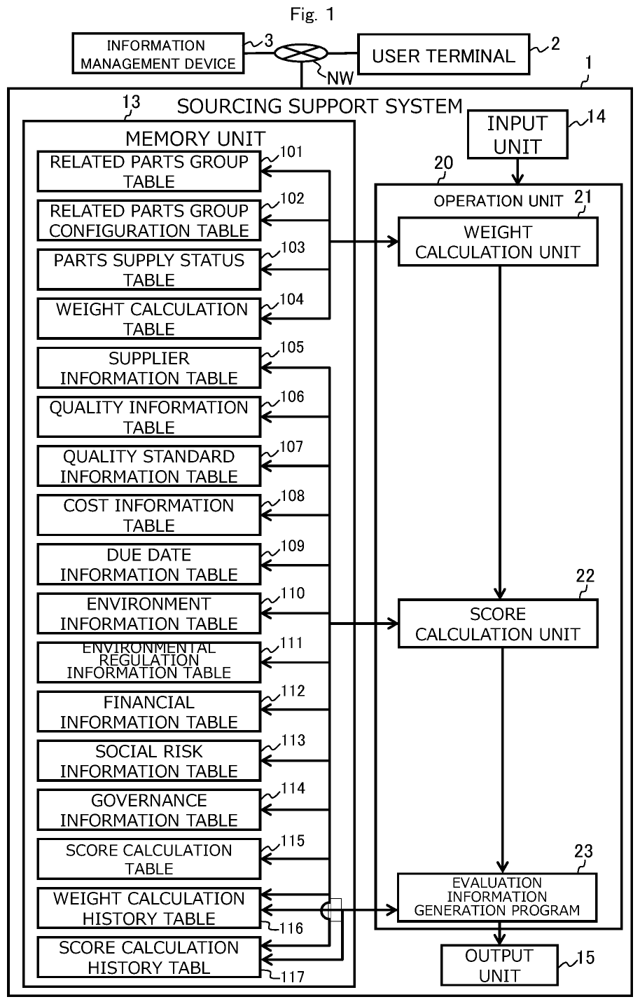

As shown in FIG. 1, the sourcing support system 1, has a functional configuration including an operation unit 20, a memory unit 13, an input unit 14 and an output unit 15. The operation unit 20 includes a weight calculation unit 21, a score calculation unit 22, and an evaluation information generation unit 23. The storage unit 13 stores a related parts group table 101 to a score calculation history table 117, as described later. The sourcing support system 1 is connected to the user terminal 2 and the information management device 3 via the network NW.

The network NW may be a wired network or a wireless network. The network NW may be a global network such as the Internet or a local area network (LAN). A wired communication path such as a universal serial bus (USB) or a wireless communication path such as Bluetooth may be used as the network NW.

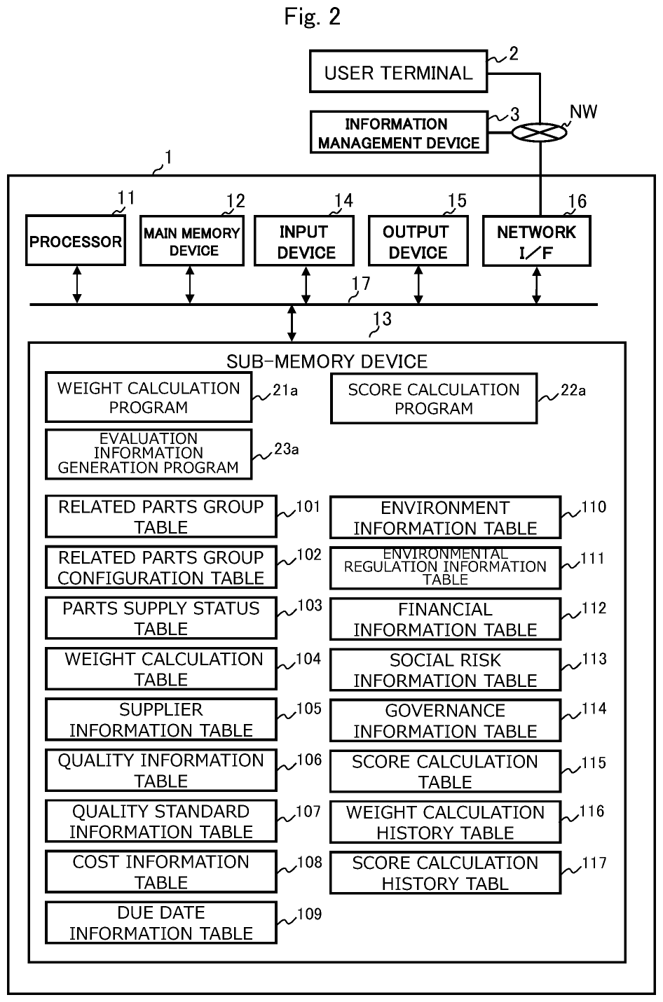

And, as shown in FIG. 2, the sourcing support system 1 has, as a hardware configuration, a processor 11, a main memory device 12, a sub-memory device 13, an input device 14, an output device 15, a network I/F 16 and a bus 17 for connecting them. The sourcing support system 1 can be realized by a general information processing apparatus such as a general server apparatus.

The user terminal 2 and the information management device 3 can be realized by the same hardware resources as those of the sourcing support system 1. The information management device 3 stores information that can supplement the information in the related parts group table 101 to the score calculation history table 117. The information management device 3 can update the stored information according to changes in the world situation. The sourcing support system 1 can access the information management device 3 to supplement the information of the related parts group table 101 to score calculation history table 117 from the information management device 3. Therefore, the sourcing support system 1 can calculate the supply capacity score Sa and the soundness score Sh reflecting the change in the world situation by calculating the supply capacity score Sa and the soundness score Sh after supplementing the information from the related parts group table 101 to the score calculation history table 117 from the information management device 3 according to the change in the world situation. Thus, when it is necessary to change the supplier of the part due to the change of the world situation, the user can let the sourcing support system 1 to calculate the supply capacity score Sa and the soundness score Sh reflecting the calculated change of the world situation. Further, the user can easily select a suitable supplier by referring to the supply capacity score Sa and the soundness score Sh calculated by the sourcing support system 1.

The processor 11 controls each unit of the sourcing support system 1, reads out the data and programs stored in the sub-memory device 13 to the main memory device 12, and executes processing determined by the programs. The weight calculation unit 21 is realized by the processor 11 reading out the weight calculation program 21a stored in the sub-memory device 13 to the main memory device 12 and executing the program. The score calculation unit 22 is realized by the processor 11 reading out the score calculation program 22a stored in the sub-memory device 13 to the main memory device 12 and executing the program. The evaluation information generation unit 23 is realized by the processor 11 reading out the evaluation information generation program 23a stored in the sub-memory device 13 to the main memory device 12 and executing the program. In this specification, when the processing is described in a sentence whose subject is the weight calculation unit 21, the score calculation unit 22 and evaluation information generation unit 23, it indicates that the processor 11 of the sourcing support system 1 executes the weight calculation program 21a, the score calculation program 22a and evaluation information generation program 23a that realize the functional unit.

The main memory device 12 is a RAM or the like, includes a volatile memory element, and stores programs executed by the processor 11, and data.

The sub-memory device 13 is an HDD (Hard Disk Drive), SSD (Solid State Drive), or the like, which has a nonvolatile storage element and stores programs, data, and the like. The weight calculation program 21a, the score calculation program 22a, and the evaluation information generation program 23a are installed in the sub-memory device 13. As described above, the weight calculation program 21a, the score calculation program 22a, and the evaluation information generation program 23a are programs that are executed by the processor 11 to realize the functions of the weight calculation unit 21, the score calculation unit 22, and the evaluation information generation unit 23, respectively.

Furthermore, the sub-memory device 13 stores the related parts group table 101, the related parts group configuration table 102, the parts supply status table 103, the weight calculation table 104, the supplier information table 105, the quality information table 106, the quality standard information table 107, the cost information table 108, the due date information table 109, the environment information table 110, the environmental regulation information table 111, the financial information table 112, the social risk information table 113, the governance information table 114, the score calculation table 115, the weight calculation history table 116, and the score calculation history table 117.

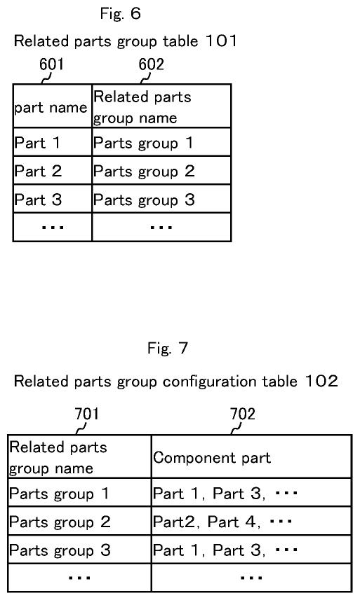

The related parts group table 101, which will be described in detail later with reference to FIG. 6, stores related parts group names that are related to parts. A related parts group is a group of parts consisting of several parts related to a part. The related parts group includes a plurality of related parts related to the multiple parts. The related parts are, for example, a plurality of parts included in an assembly including the target part as a part, or a part of the same type as the target part. For example, when the target part is a screw, the related parts may be a plurality of parts other than the screw included in the assembly part including the screw. The related parts may be a plurality of screws similar to the target part.

The related parts group configuration table 102 stores the names of a plurality of related parts included in the related parts group, which will be described in detail later with reference to FIG. 7.

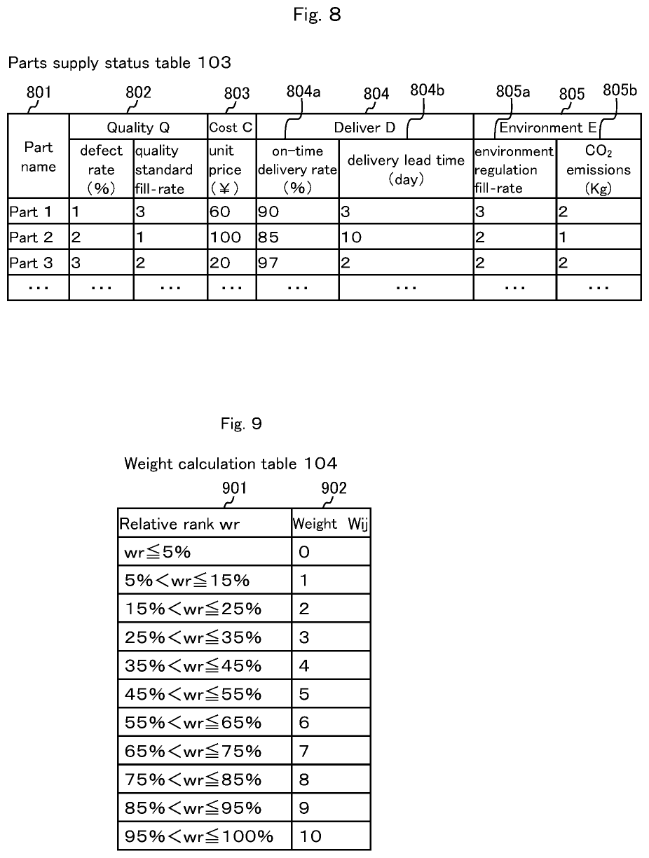

The parts supply status table 103, which will be described in detail later with reference to FIG. 8, stores information on the current evaluation value of the evaluation index of supply capacity for a part. The current evaluation value is the evaluation value for the supplier (referred to as the supplying supplier) that has supplied the target part and the related parts included in the related parts group.

In the weight calculation table 104, as will be described in detail later with reference to FIG. 9, stores the information for calculating the value of the evaluation value weight Wij from the relative rank wr of the current evaluation value of each evaluation index of supply capacity for the target part in the related parts group.

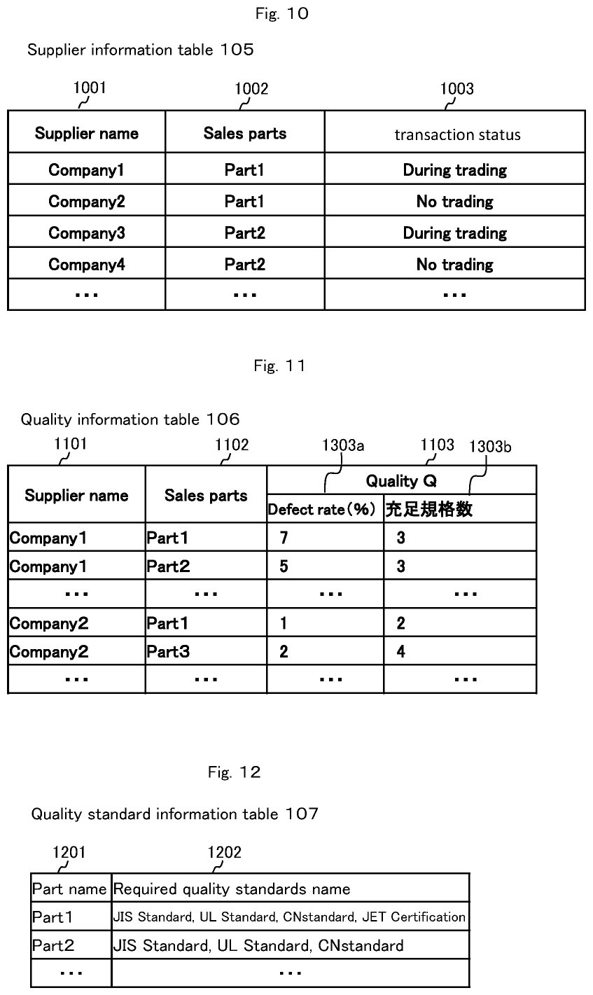

The supplier information table 105, which will be described in detail later with reference to FIG. 10, stores information of suppliers who can purchase parts.

The quality information table 106, which will be described in detail later with reference to FIG. 11, stores the information of the quality of the parts supplied by the supplier.

The quality standard information table 107, which will be described in detail later with reference to FIG. 12, stores information of a standard name required for the parts, which is required for the suppliers who manufactures the parts.

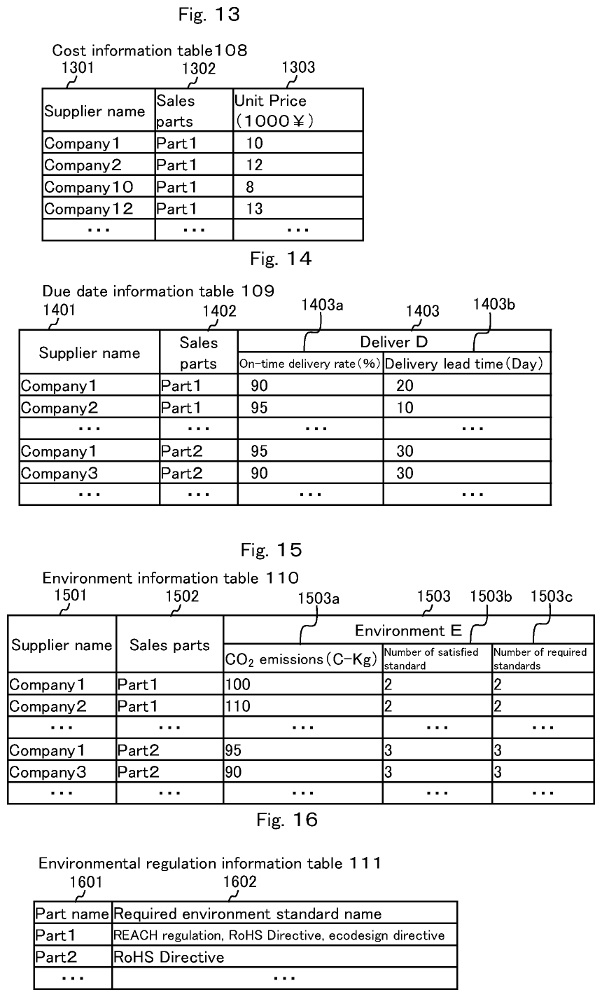

The cost information table 108, which will be described in detail later with reference to FIG. 13, stores information of the unit price of the parts of the supplier.

The due date information table 109, which will be described in detail later with reference to FIG. 14, stores the information of deliver of the parts of the supplier.

The environment information table 110, which will be described in detail later with reference to FIG. 15, stores information on the evaluation value of environment E for the supplier.

The environmental regulation information table 111, which will be described in detail later with reference to FIG. 16, stores information on standards required of suppliers for the manufacture of parts.

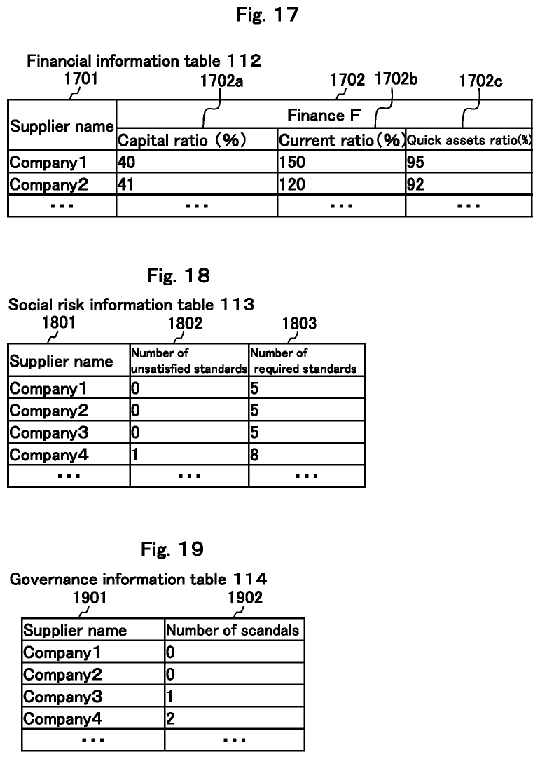

The financial information table 112, which will be described in detail below with reference to FIG. 17, stores information for evaluating the status of the finance F to the supplier.

The social risk information table 113, which will be described in detail later with reference to FIG. 18, stores information for evaluating the status of the social risk S for the supplier.

The governance information table 114, which will be described in detail later with reference to FIG. 19, stores information for evaluating the status of the governance G to the supplier.

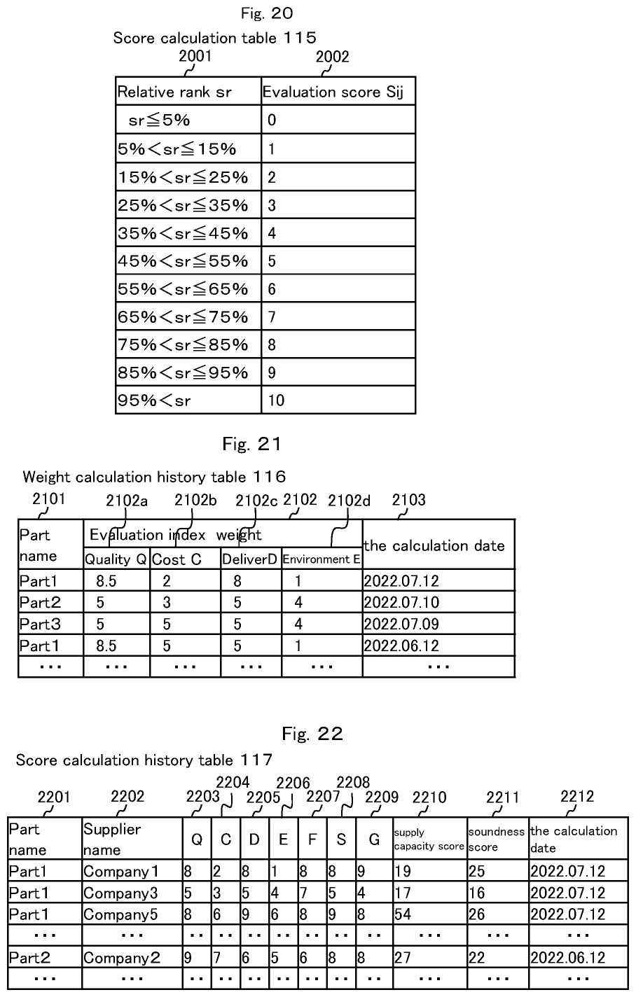

The score calculation table 115 stores information for the sourcing support system 1 to calculate the evaluation value score Sij from the relative rank sr of the numeric evaluation value of the target part in the candidate supplier group, which will be described in detail later with reference to FIG. 20.

The weight calculation history table 116 stores information of the evaluation index weight Wi calculated by the sourcing support system 1, which will be described in detail later with reference to FIG. 21.

The score calculation history table 117 stores various score S for evaluating suppliers calculated by the sourcing support system 1, which will be described in detail later with reference to FIG. 22.

The input device 14 is a device that receives a user operation, such as a keyboard or a mouse, and acquires information input by the user operation. The output device 15 is a device that outputs information, such as a display, and presents information to the user, for example, by display on a screen.

The network I/F 16 is connected to a network NW. The network I/F 16 is an interface (transmission and reception device) capable of transmitting and receiving data to and from devices such as the user terminal 2 and the information management device 3 via the network NW. The sourcing support system 1 can transmit and receive data to and from devices such as the user terminal 2 and the information management device 3 via the network NW by using the network I/F 16.

As shown in FIG. 1, the sourcing support system 1 includes the storage unit 13, the input unit 14, the output unit 15, and the operation unit 20. The storage unit 13 is the sub-memory device 13. The storage unit 13 stores the related parts group table 101 to the score calculation history table 117.

The input unit 14 includes an input device 14 and a network I/F 16. The output unit 15 includes an output device 15 and a network I/F 16. The user can input information to the sourcing support system 1 using the input unit 14. In addition, the sourcing support system 1 can output information to the output unit 15 and present the information to the user using the output unit 15. Here, the user can use the input unit 14 to input the target part name to consider the supplier, to the sourcing support system 1. The user may input the target part name to the sourcing support system 1 through the user terminal 2 by operating the user terminal 2. The target part name is an example of target part specifying information. The target part specifying information is the information that can specify the target part. The user may input target part specifying information instead of the target part name. For example, the user may input the model number of the target part to the sourcing support system 1 as the target part specifying information.

The operation unit 20 includes a weight calculation unit 21, a score calculation unit 22, and an evaluation information generation unit 23. The operation unit 20 calculates a value for evaluating the supplier who can purchase the target part from the input target part name, and outputs the value to the output unit 15. The operation unit 20 calculates a supply capacity score Sa representing the supply capacity of the supplier and a soundness score Sh representing the soundness of the supplier as values for evaluating the supplier.

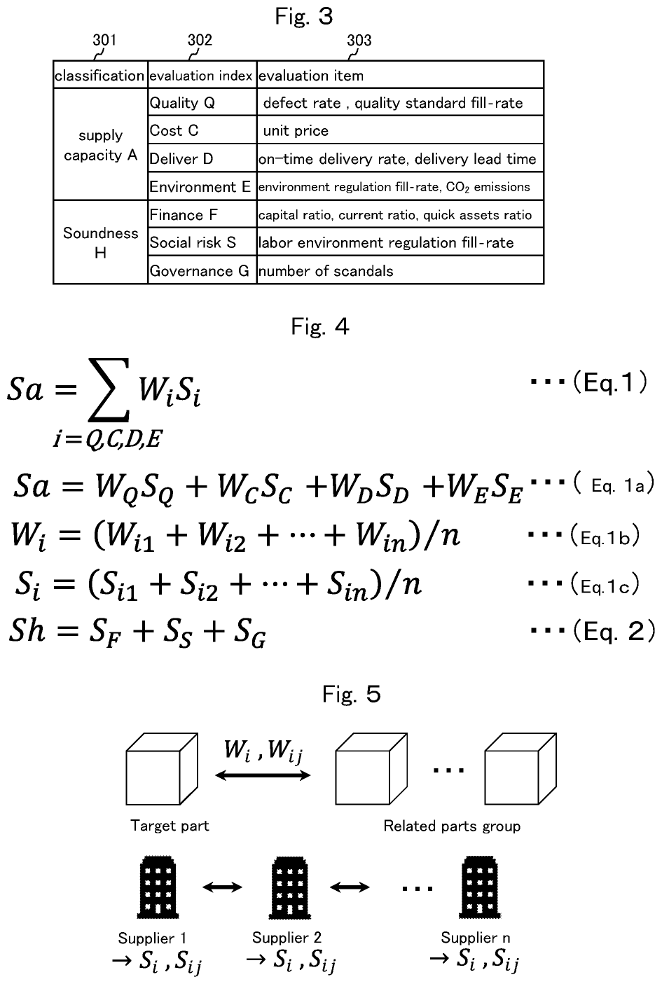

FIG. 3 is a diagram showing a table showing an example of the evaluation indexes and the evaluation items of the evaluation indexes, used to calculate the supply capacity score and the soundness score. In the sourcing support system 1, the score calculation unit 22 calculates the supply capacity score Sa and the soundness score Sh using the evaluation index score Si. The evaluation index contains one or more evaluation items. The sourcing support system 1 calculates one evaluation value for one evaluation item. The sourcing support system 1 calculates the evaluation value score Sij, which is the score for the evaluation item. The sourcing support system 1 calculates the evaluation index score Si for the evaluation index from the evaluation value score Sij. The supply capacity score Sa is calculated by weighting the evaluation index score Si for supply capacity. The soundness score Sh is the sum of the evaluation index score Si for soundness. The score calculation unit 22 of the sourcing support system 1 calculates the evaluation index score Si using the evaluation value score Sij.

As shown in the table in FIG. 3, there are four evaluation indexes of supply capacity for quality Q, cost C, deliver D, and environment E. The evaluation index of supply capacity is a index of a supplier's ability to supply parts. Here, quality Q, cost C, deliver D, and environment E are examples of the evaluation index of supply capacity. The evaluation index of supply capacity may include evaluation indexes other than quality Q, cost C, deliver D and environment E.

The quality Q evaluation items include defect rate and number of satisfied standard. The values of defect rate and number of satisfied standard for quality Q are the evaluation values for quality Q. Evaluation value is the value for the evaluation item. In this specification, the evaluation value is also referred to as “evaluation value of evaluation item” or “evaluation value of evaluation index”. There are two quality Q evaluation items: defect rate and number of satisfied standard. The quality Q evaluation value has two values: the value of the defect rate and the value of number of satisfied standard. Then, as described below, the sourcing support system 1 calculates the evaluation index score SQ of the quality Q which is the evaluation index, by using the evaluation value of the two values of the defect rate and the number of satisfied standard. Thus, the evaluation index that calculates the evaluation index score Si using multiple evaluation values is referred to as the composite evaluation index. Quality Q, deliver D, environment E, and finance F are composite evaluation indexes. The evaluation index, which calculates the evaluation index score Si using one evaluation value, is referred to as the simple evaluation index. Cost C, social risk S, and governance G are referred to as the simple evaluation index.

In addition, there are three evaluation indexes in the evaluation index of the soundness score: finance F, social risk S, and governance G. The evaluation index of soundness is an index to evaluate the soundness of the management of suppliers. The evaluation index of soundness may include evaluation indexes other than finance F, social risk S, and governance G. In this embodiment, as shown in FIG. 3, as a value for the evaluation index (finance F, social risk S, governance G) of the soundness score, for example, information of values that is easy to obtain from IR information of suppliers that is relatively easy to obtain, is used. This makes it easier to calculate and evaluate the soundness score for many suppliers.

FIG. 4 is a diagram showing an example of equations used for calculating a supply capacity score and a soundness score. As shown in Equation 1 of FIG. 4, the soundness score Sa is the sum of the products of the evaluation index weight Wi and the evaluation index score Si for the evaluation index of supply capacity (quality Q, cost C, deliver D, environment E). That is, as shown in Equation 1a of FIG. 4, the soundness score Sa is the sum of the product of the weight WQ of quality Q and the score SQ of quality Q, the product of the weight WC of cost C and the score SC of cost C, the product of the weight WD of deliver D and the deliver D score SD of deliver D, and the product of the weight WE of environment E and the score SE of environment E.

As shown in Equation 1b of FIG. 4, the evaluation index weight Wi is the mean value of the evaluation value weight Wij for the evaluation item. As shown in Equation 1c of FIG. 4, the evaluation index score Si is a mean value of the evaluation value score Sij. As described above, the sourcing support system 1 calculates the supply capacity score Sa for each supplier (referred to as “candidate supplier”) who can purchase the target part. On the other hand, the soundness score Sh is the sum of the evaluation index score S (score SF of finance F, score Ss of social risk S, and score SG of governance G) for each evaluation index of soundness.

FIG. 5 is an explanatory diagram for explaining the calculation method of the evaluation index weight Wi, evaluation value weight Wij, evaluation index score Si, and evaluation value score Sij. As shown in FIG. 5, the evaluation index weight Wi and the evaluation value weight Wij are calculated based on the evaluation value of the target part and each related part included in the related parts group related to the target part. The evaluation index weight Wi and evaluation value weight Wij are used to calculate the supply capacity score Sa as shown in Equations 1, 1a and 1b of FIG. 4. In this way, the evaluation index weight Wi and the evaluation value weight Wij, which are calculated in consideration of the related parts group related to the target part, are used to calculate the supply capacity score Sa. Thus, the sourcing support system 1 can calculate the supply capacity score Sa in consideration of the characteristics of the target part.

On the other hand, as shown in FIG. 5, the evaluation index score Si and the evaluation value score Sij are calculated based on the evaluation value of suppliers (candidate suppliers) who can purchase the target part. evaluation index score Si and evaluation value score Sij are values used to evaluate the supplier without considering the characteristics of the target part. The sourcing support system 1 stores the evaluation value necessary for calculating the supply capacity score Sa and the soundness score Sh in the storage unit 13 (sub-memory device 13). The method of calculating the supply capacity score Sa and the soundness score Sh has been described above.

When the name (target part name) of the target part whose supplier is to be examined is input, the weight calculation unit 21 refers to the related parts group table 101 to acquire the related parts group name for the target part.

The related parts group is a group of parts related to the target part.

The weight calculation unit 21 refers to the related parts group configuration table 102 (see FIG. 6) to the parts supply status table 103 (see FIG. 8), and acquires the current evaluation value of each evaluation index of supply capacity for the target part and each related parts included in the related parts group. The current evaluation value is the evaluation value for a supplier (referred to as a supplying supplier) that has previously supplied the target part the related parts and included in the related parts group.

The weight calculation unit 21 calculates the evaluation value weight Wij based on the weight calculation table 104 (see FIG. 9) and the current evaluation value of each evaluation index of supply capacity for each the target part and the related part included in the acquired related parts group. the evaluation value weight Wij is the value of the weight associated with the evaluation item. Here, the sourcing support system 1 calculates the evaluation value weights Wij corresponding to each evaluation item of the evaluation index of supply capacity.

The weight calculation unit 21 calculates the mean value of the evaluation value weight Wij (see Equation 1b in FIG. 4) of the evaluation item as the evaluation index weight Wi. In this manner, the weight calculation unit 21 calculates the evaluation index weight Wi (WQ, WC, WD, WE) of each evaluation index of supply capacity (quality Q, cost C, deliver D, environment E).

The score calculation unit 22 refers to the supplier information table 105 (see FIG. 10) to calculate the candidate supplier group name for the target part. A candidate supplier is a supplier who can purchase a target part. The candidate supplier group is a group of a plurality of candidate suppliers.

The score calculation unit 22 calculates the supply capacity score Sa and the soundness score Sh for each candidate supplier included in the calculated candidate supplier group name (candidate supplier group) as follows.

1, The score calculation unit 22 calculates the evaluation index score Si of each of the evaluation index of supply capacity (quality Q, cost C, deliver D, environment E) with reference to the quality information table 106 (see FIG. 11) to the environmental regulation information table 111 (see FIG. 16) and the score calculation table 115 (see FIG. 20). Then, the score calculation unit 22 calculates the sum of the products of the evaluation index weight Wi calculated by the weight calculation unit 21 and the evaluation index score Si to the evaluation index of supply capacity as the supply capacity score Sh (see Equation 1 in FIG. 4).

2, The score calculation unit 22 refers to the financial information table 112 (see FIG. 17) to the governance information table 114 (see FIG. 19) and the score calculation table 115 (see FIG. 20) to calculate the evaluation index score Si of each evaluation index of soundness (finance F, social risk S, governance G). Then, the score calculation unit 22 calculates the sum of the evaluation index score S (SF, SS, and SG) of the evaluation index of soundness as the soundness score Sa (see Equation 2 in FIG. 4).

The score calculation unit 22 stores the evaluation index weight Wi in the weight calculation history table 116 (see FIG. 21). The score calculation unit 22 stores the evaluation index score Si, supply capacity score Sa, soundness score Sh, and the like in a score calculation history table 117 (see FIG. 22).

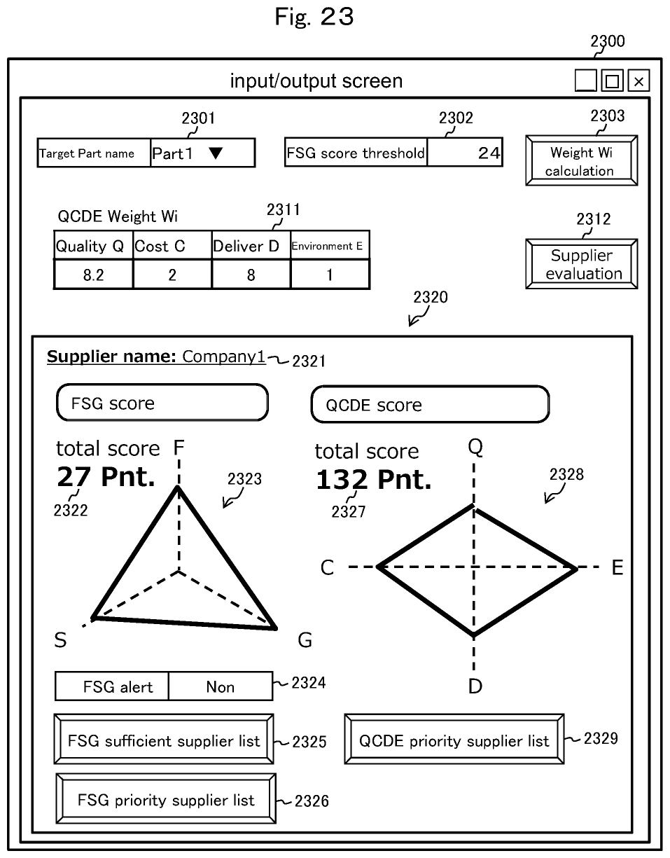

The evaluation information generation unit 23 outputs the supplier evaluation information (see FIG. 28) in which the candidate supplier name (supplier specifying information), the supply capacity score Sa, and the soundness score Sh are associated with each other, to the output device 15, according to an instruction input from the input/output screen (see FIG. 23) by the user. The output device 15 present the supplier evaluation information.

There are three types of supplier evaluation information: the soundness sufficient suppliers table, the soundness score priority candidate supplier table, and the supply capacity score priority candidate supplier table. As shown in FIG. 28, the soundness sufficient suppliers table is information in which the supply capacity score Sa, the soundness score Sh, and the soundness sufficient candidate supplier name (sound supplier specifying information) capable of specifying the soundness sufficient candidate supplier, are stored in association with each other. Among the candidate suppliers, suppliers whose soundness score Sa is larger than a predetermined soundness threshold (referred to as “soundness sufficient candidate suppliers”) are listed in descending order of supply capacity score Sa.

On the other hand, the soundness score priority candidate supplier table is information in which the supply capacity score Sa, the soundness score Sh, and the candidate supplier name are stored in association with each other, where all the candidate suppliers are arranged in descending order of the soundness score Sa. The supply capacity score priority candidate supplier table is information that associates and stores the supply capacity score Sa, the soundness score Sh, and the candidate supplier name, where all the candidate suppliers are listed in descending order of supply capacity score Sh.

### <<Data Configuration of Sourcing Support System 1>>

Next, the data configuration of various types of data used in the sourcing support system 1 will be described with reference to FIG. 6 to FIG. 22.

FIG. 6 is a diagram showing an example of the data configuration of the related component group table 101. The related parts group table 101 has a part name 601 and a related parts group name 602 as fields.

The part name 601 is a part name. The related parts group name 602 is a name of a related parts group for the part of the part name 601.

FIG. 7 is a diagram showing an example of the data configuration of the related parts group configuration table 102. The related parts group configuration table 102 has a related parts group name 701 and a component part 702 as fields. The related parts group name 701 is the name of the related parts group. The component part 702 is the name of the related parts included in the related parts group name 701.

FIG. 8 is a diagram showing an example of the data configuration of the parts supply status table 103. The parts supply status table 103 has, as fields, a part name 801, a current evaluation value 802 of quality Q, a current evaluation value 803 of cost C, a current evaluation value 804 of deliver D, and a current evaluation value 805 of environment E. The current evaluation values 802 to 805 are the evaluation value (current evaluation value) of the evaluation index of supply capacity for the supplier (supplying supplier) that supplied the part with the part name 801.

The part name 801 is a part name. The current evaluation value 802 of the quality Q is the field of the current evaluation value of the quality Q of the part of the part name 801. The current evaluation value 802 of the quality Q includes the defect rate 802a and the number of required quality standards 802b.

The current evaluation value 803 of the cost C is the current evaluation value of the cost C of the part with the part name 801, and is the unit price of the part with the part name 801.

The current evaluation value 804 of the deliver D is the field for the the current evaluation value of the deliver D to the part with the part name 801. The current evaluation value 804 of the deliver D includes the on-time delivery rate 804a and the delivery lead time 804b.

The current evaluation value 805 of the environment E is the field for the current evaluation value of the environment E to the part with the part name 801. The current evaluation value 805 of the environment E includes the number of required environment standards 805a and CO2 emissions 805b.

FIG. 9 is a diagram showing an example of the data configuration of the weight calculation table 104. The weight calculation table 104 has a relative rank wr 901 and an evaluation value weight Wij 902 as fields. The relative rank wr 901 is the relative rank wr of the current evaluation value of the evaluation index of supply capacity of the related parts group for the target part.

FIG. 10 is a diagram showing an example of the data configuration of the supplier information table 105. The supplier information table 105 has, as fields, a supplier name 1001, a sales part name 1002, and a transaction status 1003. The supplier name 1001 is the name of the supplier. The sales part name 1002 is the name of the part that can be purchased from the supplier of the supplier name 1001. The part name is a kind of part specifying information that can specify the part. The value of sales part name 1002 may be part specifying information, and the value of sales part name 1002 may be the model number of the part. The transaction status 1003 is a status of a transaction with the supplier of the supplier name 1001.

FIG. 11 is a diagram showing an example of the data configuration of the quality information table 106. The quality information table 106 has, as fields, a supplier name 1101, a sales part 1102, and an quality Q evaluation value 1103. The supplier name 1101 is the name of a supplier. The sales part 1102 is the name of the part that can be purchased from the supplier with supplier name 1101. The evaluation value 1103 of the quality Q is the field of evaluation value of the quality Q of the part of sales part 1102. The evaluation value 1103 of the quality Q includes a defect rate 1103a and a number of satisfied standard 1103b as evaluation values. The number of satisfied standard 1103b is the number of standards of the part of the sales part 1102 that have been acquired (satisfied) by the supplier of supplier name 1101. The standard is a standard for evaluating suppliers or parts, such as regulatory standards or certification standards.

FIG. 12 is a diagram showing an example of the data configuration of the quality standard information table 107. The quality standard information table 107 has the part name 1201 and the required quality standards name 1202 as fields. The part name 1201 is the name of the part. The required quality standards name 1202 is the name of the quality standard required for the part with the part name 1201. The quality standard is a standard for evaluating suppliers or parts, such as regulatory standards of quality or certification standards of quality.

FIG. 13 is a diagram showing an example of the data configuration of the cost information table 108. The cost information table 108 has, as fields, a supplier name 1301, a sales part 1302, and an unit price 1103. The supplier name 1301 is a name of a supplier. The sales part 1302 is the name of the part that can be purchased from the supplier with supplier name 1301. The unit price 1303 is the unit price of the part with the sales part 1102 as the evaluation value.

FIG. 14 is a diagram showing an example of the data configuration of the due date information table 109. The due date information table 109 has, as fields, a supplier name 1401, a sales part 1402, and an deliver D evaluation value 1403. The supplier name 1401 is a name of a supplier. The sales part 1402 is the name of the part that can be purchased from the supplier with supplier name 1401. The evaluation value 1403 of the deliver D is the field of the evaluation value of the deliver D of the part of sales part 1402. The evaluation value 1403 of the deliver D includes an on-time delivery rate 1403a and a delivery lead time 1403b as evaluation values.

FIG. 15 is a diagram showing an example of the data configuration of the environment information table 110. The environment information table 110 has, as fields, a supplier name 1501, a sales part 1502, and an environment E evaluation value 1503. The supplier name 1501 is a name of a supplier. The sales part 1502 is the name of the part that can be purchased from the supplier with supplier name 1501. The evaluation value 1503 of the environment E is the field of the evaluation value of the environment E of the part of sales part 1502. The evaluation value 1503 of the environment E includes CO2 emissions 1503a, number of satisfied standard 1503b, and number of required standards 1503c, as evaluation values. The number of satisfied standard 1503b is the number of standards (environment standards) of the part of the sales part 1502 that have been acquired (satisfied) by the supplier of the supplier name 1501. The number of required standards 1503c is the number of environmental standards required for the part in sales part 1502. Here, the environment standard is a standard for evaluating suppliers and the parts, such as the standard of regulation relating to the global environment or a standard for certification to the global environment.

FIG. 16 is a diagram showing an example of the data configuration of the environmental regulation information table 111. The environmental regulation information table 111 has the part name 1601 and the required environment quality standards name 1602 as fields. The part name 1601 is the name of the part. The required environment quality standards name 1602 is the name of the environment standard required for the part in the part name 1601.

FIG. 17 is a diagram showing an example of the data configuration of the financial information table 112. The financial information table 112 has, as fields, a supplier name 1701 and an finance F evaluation value 1702. The supplier name 1701 is the name of the supplier. The finance F evaluation value 1702 is a field of the evaluation value of the finance F of the supplier. The finance F evaluation value 1702 includes a capital ratio 1702a, a current ratio 1702b, and a quick assets ratio 1702c as evaluation values.

FIG. 18 is a diagram showing an example of the data configuration of the social risk information table 113. The social risk information table 113 has, as fields, a supplier name 1801, an number of unsatisfied standard 1802 of the supplier name 1801, and an number of required standards 1803 of the supplier name 1801. The supplier name 1801 is a name of a supplier. The number of unsatisfied standard 1802 is the number of unfulfilled compliance standards for which the supplier with supplier name 1801 is missing. The number of required standards 1803 is the number of compliance standards required for the supplier with supplier name 1801 to manufacture the part.

FIG. 19 is a diagram showing an example of the data configuration of the governance information table 114. The governance information table 114 has, as fields, a supplier name 1901 and a number of scandals 1902. The number of scandals 1902 is the number of scandals caused by the supplier with the supplier name 1901.

FIG. 20 is a diagram showing an example of the data configuration of the score calculation table 115. The score calculation table 115 has, as fields, a relative rank sr 2001 and an evaluation value score Sij 2002. The relative rank sr 2001 is the relative rank sr of the numeric evaluation value of the target part in the candidate supplier group. The evaluation value score Sij 2002 is the value of the evaluation value score Sij.

FIG. 21 is a diagram showing an example of the data configuration of the weight calculation history table 116. The weight calculation history table 116 has the part name 2101, the evaluation index weight 2102, and the calculation date 2103 as fields. The part name 2101 is the name of the target part. The evaluation index weight 2102 is the evaluation index weight field. The evaluation index weight 2102 includes, as values of the evaluation index weight, an evaluation index weight of quality QWQ 2102a, an evaluation index weight of cost WC 2102b, an evaluation index weight of deliver WD 2102c, and an evaluation index weight of environment WE 2102d. The calculation date 2103 is the date on which the sourcing support system 1 calculated the evaluation index weight 2102.

FIG. 22 is a diagram showing an example of the data configuration of the score calculation history table 117. The score calculation history table 117 has, as fields, the part name 2201, the supplier name 2202, the quality Q evaluation index score SQ 2203, the cost C evaluation index score SC 2204, the deliver D evaluation index score SD 2205, the environment E evaluation index score S 2206, the finance F evaluation index score S 2207, the social risks evaluation index score S 2208, the governance G evaluation index score S 2209, the supply capacity score Sa 2210, the soundness score Sh 2211, and the calculation date 2212.

The part name 2201 is the name of the target part.

The supplier name 2202 is a name of a candidate supplier.

The calculation date 2212 is the date on which the quality Q evaluation index score SQ 2203 to soundness score Sh 2211 was calculated by the sourcing support system 1.

### <<Processing Procedure of The Sourcing Support System 1, FIG. 23 to FIG. 28>>

Next, the processing procedure for sourcing support system 1 is described. A User operates user terminal 2 to allow user terminal 2 to access sourcing support system 1. When the sourcing support system 1 is accessed from the user terminal 2, sourcing support system 1 sends the input/output screen information, which is the input/output screen information, to the user terminal 2. The input/output screen information includes information on the configuration of the input/output screen and the information indicating that the input/output screen is to be displayed on the user terminal 2. As described below, the input/output screen is configured to be able to receive an input of a target part name, an input of an instruction to calculate a value for evaluating suppliers, and an input indicating that the evaluation result of the suppliers is to be displayed.

FIG. 23 is an explanatory diagram showing an example of an input/output screen. The input/output screen 2300 shown in FIG. 23 has a target part selection button 2301, a soundness threshold input column 2302, a weight calculation execution button 2303, a weight list 2311, a supplier evaluation execution button 2312, and a supplier evaluation result display column 2320.

The target part selection button 2301 is a button for entering the target part name, which is the name of the part for which the supplier is to be considered. When the target part selection button 2301 is pressed, a list of the part names is displayed. The input/output screen 2300 allows the user to set the target part name to the name of the part selected from the list of displayed part names.

The soundness threshold input column 2302 is a column where the user enters the soundness threshold, which will be described later. The soundness threshold input column 2302 displays the initial value, so that when the user enters a number in the soundness threshold input column 2302, the soundness threshold input column 2302 displays and the soundness threshold changes to the entered number.

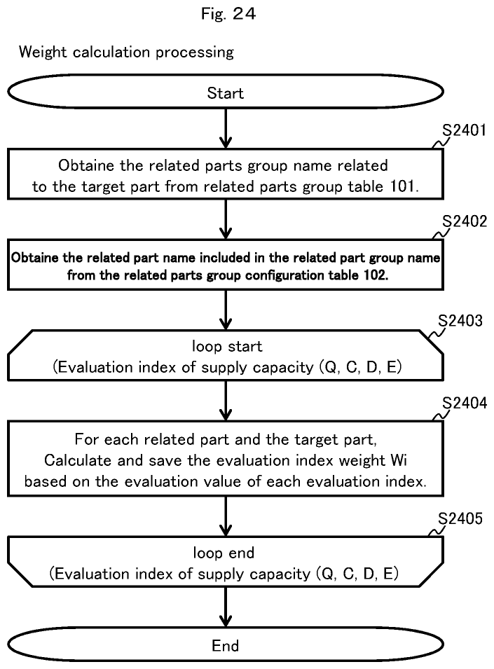

The weight calculation execution button 2303 is a button for entering instructions for starting the weight calculation processing. When the weight calculation execution button 2303 is pressed by the user, the sourcing support system 1 executes the weight calculation processing (see FIG. 24) with the target part name selected by the user in the target part selection button 2301 as input.

The weight list 2311 shows the evaluation index weight of supply capacity Wi calculated by the weight calculation processing by the sourcing support system 1. Users can change the evaluation index weight Wi by entering a number in the evaluation index weight Wi column in weight list 2311. This allows the user to change the evaluation index weight Wi as appropriate, and then have the sourcing support system 1 calculate and display the supply capacity score Sa and the soundness score Sh of candidate suppliers as described below. For example, if it is desired to obtain information about a supplier whose delivery of the part is short, the value of evaluation index weight of deliver WD should be larger than the other evaluation index weights Wi. This increases the contribution of the evaluation value of deliver D in the supply capacity score Sa, so that users can easily evaluate candidate suppliers with emphasis on deliver D by referring to the supply capacity score Sa.

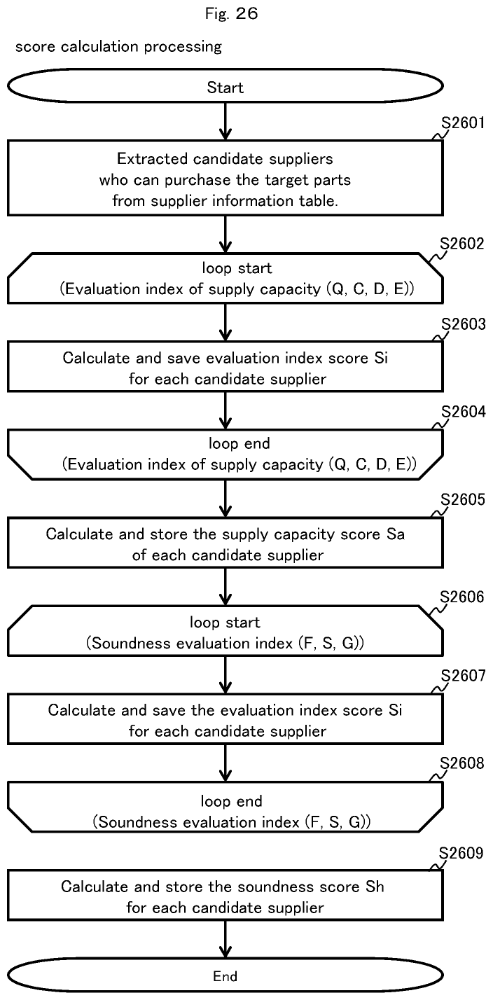

The supplier evaluation execution button 2312 is used to enter instructions for starting the score calculation processing. When the supplier evaluation execution button 2312 is pressed by the user, the sourcing support system 1 executes score calculation processing (see FIG. 26) with the target part name selected by the user in the target part selection button 2301, the soundness threshold entered in the soundness threshold input column 2302, and the evaluation index weight of supply capacity Wi calculated by the sourcing support system 1 in the weight calculation processing, displayed in the weight list 2311, as inputs.

The supplier evaluation result display column 2320 is a column that displays the value to evaluate the suppliers as calculated by sourcing support system 1 through the score calculation processing. The supplier evaluation result display column 2320 includes candidate supplier name 2321, soundness score display column 2322, soundness chart 2323, soundness alert display column 2324, soundness sufficient suppliers table display button 2325, soundness priority supplier table display button 2326, supply capacity score display column 2327, supply capacity chart 2328, and supply capacity priority supplier table display button 2329.

Candidate supplier name 2321 is a column that displays the candidate supplier name associated with the information in soundness score display column 2322, soundness chart 2323, soundness alert display column 2324, supply capacity score display column 2327, and supply capacity chart 2328.

Soundness score display column 2322 is a column that displays the soundness score Sh of candidate supplier with candidate supplier name 2321. Health chart 2323 is a radar chart of the evaluation index of soundness score Si of candidate supplier with candidate supplier name 2321.

Soundness alert display column 2324 is a column that displays whether the soundness score Sh of candidate supplier with candidate supplier name 2321 exceeds the soundness threshold. If the soundness score Sh of the candidate supplier with candidate supplier name 2321 is less than or equal to the soundness threshold (soundness score Sh≤soundness threshold), the soundness alert display column 2324 displays an “Yes” indicating that the soundness of the candidate supplier with candidate supplier name 2321 can be judged to be insufficient by the soundness score Sh of the candidate supplier being less than or equal to the soundness threshold. On the other hand, if the soundness score Sh is greater than the soundness threshold (soundness threshold<soundness score), the soundness alert display column 2324 displays “No” indicating that the soundness of the candidate supplier with candidate supplier name 2321 can be judged to be sufficient by the soundness score Sh of the candidate supplier with candidate supplier name 2321 being greater than the soundness threshold.

The soundness sufficient suppliers table display button 2325 is a button for inputting an instruction to present a soundness sufficient supplier evaluation value table (see FIG. 28) in which candidate suppliers whose soundness score Sh is greater than the soundness threshold (soundness sufficient candidate suppliers) are arranged in descending order of supply capacity score Sa. When the user presses the soundness sufficient suppliers table display button 2325, the evaluation information generation unit 23 of the sourcing support system 1 generates a soundness sufficient supplier evaluation value table (soundness sufficient suppliers table, see FIG. 28), outputs the generated soundness score priority supplier evaluation value table, and causes the user to present the generated table.

A soundness priority supplier table display button 2326 is a button for inputting an instruction to display a soundness score priority supplier evaluation value table (not shown) in which candidate suppliers are arranged in descending order of soundness score Sh, and the supplier name, evaluation index score Si, supply capacity score Sa, and soundness score Sh are associated with each other. When the user presses the soundness priority supplier table display button 2326, the evaluation information generation unit 23 of the sourcing support system 1 generates a s soundness score priority supplier evaluation value table (not shown), outputs the generated soundness score priority supplier evaluation value table, and present the table to the user.

The supply capacity score display column 2327 is a column for displaying the supply capacity score Sa of the candidate supplier with the candidate supplier name 2321. The supply capacity chart 2328 is a radar chart of the evaluation index score of supply capacity Si of the candidate supplier with the candidate supplier name 2321.

The supply capacity priority supplier table display button 2329 is a button for inputting an instruction to present a supply capacity priority supplier evaluation value table (not shown) in which candidate suppliers are arranged in descending order of supply capacity score Sa, and the supplier name, evaluation index score Si, supply capacity score Sa, and soundness score Sh are associated with each other. When the user presses the supply capacity priority supplier table display button 2329, the evaluation information generation unit 23 of the sourcing support system 1 generates a supply capacity priority supplier evaluation value table (not shown), outputs the generated supply capacity priority supplier evaluation value table, and causes the user to present the generated table.

As described above, the input/output screen 2300 receives an instruction to execute the weight calculation processing of the weight calculation unit 21, an instruction to execute the score calculation processing of the score calculation unit 22, and an instruction to execute the processing of the evaluation information generation unit 23. When the user presses the weight calculation execution button 2303, the weight calculation unit 21 of the sourcing support system 1 executes weight calculation processing (see FIG. 24) with the target part name (target part specifying information) input using the target part selection button 2301 as an input.

The user may also input a soundness threshold using a soundness threshold input column 2302. When the user presses the supplier evaluation execution button 2312, the sourcing support system 1 executes score calculation processing (see FIG. 26) with the target part name input using the target part selection button 2301, the soundness threshold input using the soundness threshold input column 2302, and the evaluation index weight of supply capacity Wi displayed in the weight list 2311 as inputs.

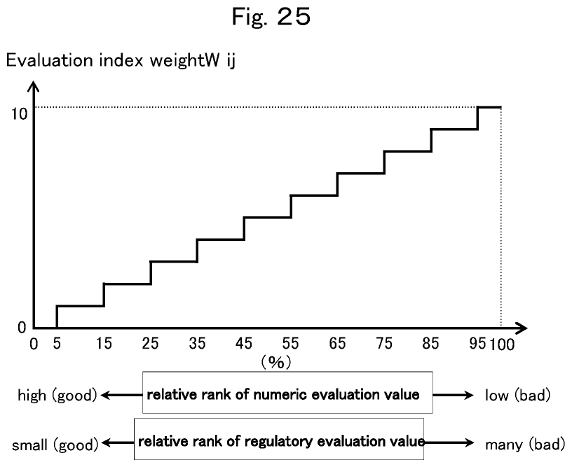

The evaluation information generation unit 23 of the sourcing support system 1 displays the evaluation result of the supplier calculated by the score calculation processing in the supplier evaluation result display column 2320. When any one of the soundness sufficient suppliers table display button 2325, the soundness priority supplier table display button 2326, and the supply capacity priority supplier table display button 2329 of the supplier evaluation result display column 2320 is pressed, the evaluation information generation unit 23 of the sourcing support system 1 generates a table corresponding to the pressed button, outputs the generated table to the output device 15 or the network I/F 16, and causes the user to present the generated table. The processing of the weight calculation unit 21, the score calculation unit 22, and the evaluation information generation unit 23 will be described in detail below.

<Weight Calculation Processing, FIGS. 24 and 25>

FIG. 24 is a flowchart showing an example of a weight calculation processing of the embodiment. When the target part name is input to the input/output screen 2300 (see FIG. 23) and the weight calculation execution button 2303 is pressed, the weight calculation unit 21 (see FIG. 1) of the sourcing support system 1 executes the weight calculation processing shown in FIG. 24 as an example with the target part name as input.

The sourcing support system 1 acquires the related parts group name associated with the target part name from the related parts group table 101 (see FIG. 6) and stores the acquired related parts group name (step S 2401).

Next, the sourcing support system 1 acquires the related parts name associated with the related parts group name from the related parts group configuration table 102 and stores the acquired related parts name (step S 2402).

Next, the sourcing support system 1 starts loop processing for calculating the evaluation index weight of supply capacity Wi from the target part name (step S 2403). The processing shown from the loop start step 2403 to the loop end step 2405 is repeated for each evaluation index of supply capacity (quality Q, cost C, deliver D, environment E). In step 2403, the sourcing support system 1 selects one evaluation index of supply capacity from the list of the unprocessed evaluation indexes of supply capacity.

Next, the sourcing support system 1 calculates the weight of evaluation index Wi of the evaluation index of supply capacity selected in step 2403 based on the current evaluation value of each evaluation index for each of the related parts and the target part, and stores it in the weight calculation history table 116 (step S 2404).

In step 2404, the sourcing support system 1 first performs the following processes (1A) to (1C) to calculate all evaluation values weight Wij for the evaluation item.

(1A) The sourcing support system 1 obtains the current evaluation values (current evaluation values associated with each of the related parts and the target part) associated with each of the related parts names and the target part name, from the parts supply status table 103 (see FIG. 6). And, the sourcing support system 1 stores the obtained current evaluation value in association with the obtained.

(1B) The sourcing support system 1 calculates the rank of the current evaluation value of the target part in the related parts group based on all the acquired current evaluation values. Further, the sourcing support system 1 calculates the relative rank wr (%) of the current evaluation value of the target part in the related parts group. There are two types of current evaluation value: numeric current evaluation value and regulatory current evaluation value. The numeric current evaluation values include defect rate for quality Q, unit price for cost C, on-time delivery rate and delivery lead time for deliver D, and CO2 emissions for environment E. On the other hand, there are two regulatory current evaluation values: the number of required quality standards (quality regulation fill-rate) for quality Q and the number of required environment standards (environment regulation fill-rate) for environment E.

The relative rank wr of the current evaluation value is calculated for all current evaluation values (both numeric and regulatory) such that the higher the rank, the better the current evaluation value. That is, for the numeric current evaluation value, the rank is calculated such that the higher the rank of the current evaluation value is, the better the current evaluation value is, and the relative rank wr (%) is calculated by dividing the calculated rank by the number of related parts. And, the fewer the number of required standards, the fewer the standards that are imposed on the part. Therefore, in the case of the regulatory current evaluation value, the rank of number of required standards is calculated so that the rank is higher as the number of required standards is smaller, and the calculated rank is divided by the number of related parts to calculate the relative rank wr (%).

(1C) The sourcing support system 1 obtains the evaluation value weight Wij corresponding to the relative rank wr of the current evaluation value of the target part from the weight calculation table 104 (see FIG. 9).

FIG. 25 is a graph for explaining the relationship between the values of the evaluation value weight Wij or the evaluation value weight Wi, and the ranking of the current evaluation value of the target part. FIG. 25 is a graph created based on FIG. 9. As shown in FIG. 9, the weight calculation table 104 is generated such that the value of the evaluation value weight Wij becomes larger as the relative rank wr (%) of the current evaluation value becomes lower. Therefore, as shown in FIG. 25, as the relative rank wr (%) of the current evaluation value is lower, that is, as the current evaluation value is a relatively worse value in the related parts group, the value of the evaluation value weight Wij is set to be larger. The evaluation index weight Wi is the arithmetic mean of the evaluation value weight Wij. Therefore, the evaluation index weight Wi becomes larger as the evaluation value weight Wij becomes larger. Therefore, the evaluation index weight Wi is set such that the lower the relative rank wr of the current evaluation value is (current evaluation value is a relatively bad value), the evaluation index weight Wi becomes the larger the value. As described above, instead of acquiring the evaluation value weight Wij from the relative rank wr (%) by using the weight calculation table 104, the sourcing support system 1 may acquire the evaluation value weight Wij from the relative rank wr by using a function (for example, relative rank wr (%)×10).

The sourcing support system 1 then calculates the arithmetic mean of the evaluation value weight Wij as the evaluation index weight Wi (see Equation 1b in FIG. 4).

A more specific calculation method of the evaluation index weight Wi described above is described below. There are four evaluation indices of supply capacity: quality Q, cost C, deliver D, and environment E. For these four evaluation indexes, the sourcing support system 1 calculates an evaluation index weight Wi as described below.

The two quality Q evaluation items are the defect rate and the number of required quality standards. The evaluation value weight WQ 1 of the defect rate is calculated as follows: (1A) For each related part, the sourcing support system 1 searches the parts supply status table 103 for a record in which the part name 801 is the related part name. The sourcing support system 1 sets the value of the defect rate 802a of the retrieved record as the value of the defect rate. The sourcing support system 1 stores the value of the defect rate and the related parts name in association with each other.

Next, (1B) the sourcing support system 1 calculates the rank of the defect rate of the target part in the related parts group based on the values (current evaluation values) of the defect rates of all the acquired related parts. In addition, the sourcing support system 1 calculates the relative rank wr (%) of the current evaluation value of the target part. The lower the defect rate (%), the better. Therefore, the sourcing support system 1 calculates the rank of the defect rate (current evaluation value) of the related parts, so that the rank of the related parts having a low defect rate (current evaluation value) becomes high. Then, the sourcing support system 1 calculates a relative rank wr (%) of the defect rate (current evaluation value) of the target part by dividing the rank of the defect rate of the target part by the number of related parts.

Next, (1C) the sourcing support system 1 obtains the evaluation value rank wr WQ 1 corresponding to the relative weight of the defect rate (current evaluation value) of the target part from the weight calculation table 104.

The sourcing support system 1 calculates the evaluation value weight WQ 2 of the number of required quality standards (quality regulation fill-rate) of the evaluation items of the quality Q as follows. The number of required quality standards is a type of regulatory current evaluation value. (1A) The sourcing support system 1 acquires the value of the number of required quality standards 802b for each of the related parts from the parts supply status table 103 in the same manner as the acquisition of the value of the defect rate described above. Next, (1B) the sourcing support system 1 calculates the rank of the number of required quality standards (current evaluation value) of the target part in the related parts group, and further calculates the relative rank wr (%) of the number of required quality standards (current evaluation value) of the target part. Next, (1C) sourcing support system 1 obtains evaluation value weight WQ 2 corresponding to the relative rank wr of the number of required quality standards (current evaluation value) of the target part from weight calculation table 104.

As described above, when the sourcing support system 1 calculates the evaluation values weight WQ 1 and WQ 2 of all the quality Q evaluation items (defect rate, quality regulation fill-rate), the sourcing support system 1 calculates the arithmetic average of the evaluation values WQ 1 and WQ 2 of all the quality Q evaluation items (defect rate, quality regulation fill-rate) as the evaluation index weight of quality QWQ (WQ=(WQ 1+WQ 2)/2).

The cost C evaluation item is only unit price. The lower the unit price, the better. The sourcing support system 1 calculates evaluation value weight WC 1 of the cost C in the same manner as the evaluation value weight WQ 1 of the defect rate of the quality Q described above, and the sourcing support system 1 uses the calculated evaluation value weight WC 1 of the cost C as the evaluation index weight of cost WC.

The deliver D evaluation item is a two numeric evaluation item: the on-time delivery rate (%) and the delivery lead time (days). The sourcing support system 1 calculates the evaluation value weight WD 1 of the on-time delivery rate and the evaluation value weight WD 2 of the delivery lead time in the same manner as the evaluation value weight WQ 1 of the defect rate of the quality Q. Then, the sourcing support system 1 calculates the arithmetic mean of the evaluation value weight WD 1 and WD 2 of all the deliver D evaluation items (on-time delivery rate, delivery lead time) as the evaluation index weight of deliver WD (WD=(WD 1+WD 2)/2).

The environment E evaluation item consists of two evaluation items: the number of required environment standards (environment regulation fill-rate) and CO2 emissions. The number of required environment standards (environment regulation fill-rate) is a type of regulatory current evaluation value. On the other hand, CO2 emissions is a kind of numeric current evaluation value. The sourcing support system 1 calculates the evaluation value weight WE 1 of the number of required environment standards (environment regulation fill-rate) in the same manner as the evaluation value weight WQ 2 of the number of required quality standards (quality regulation fill-rate) of quality Q described above. The sourcing support system 1 calculates the evaluation value weight WE 2 of the CO2 emissions in the same manner as the evaluation value weight WQ 1 of the defect rate of the quality Q described above. Then, the sourcing support system 1 calculates the arithmetic mean of the evaluation value weight WE 1 and WE 2 of all the environment E evaluation items (the number of required environment standards, CO2 emissions) as the evaluation index weight of deliver WE (WE=(WE 1+WE 2)/2).

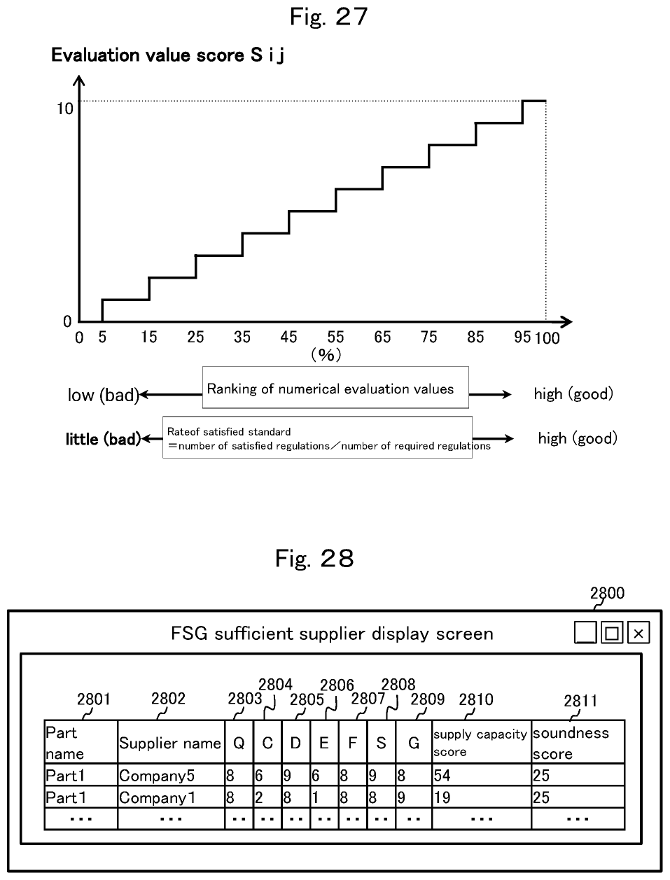

Next, the sourcing support system 1 judges whether the processing is completed for all the evaluation indexes (quality Q, cost C, deliver D, environment E) of the supply capacity (step S 2405). If the sourcing support system 1 judges that the processing has not been completed for all the evaluation indexes of the supply capacity, the sourcing support system 1 returns to the step S 2403 to continue the processing. On the other hand, when the sourcing support system 1 judges that the processing has been completed for all the evaluation indexes of the supply capacity, the sourcing support system 1 ends the weight calculation processing.

<Score Calculation Processing, FIGS. 26 and 27>

FIG. 26 is a flowchart showing an example of a score calculation processing of the embodiment. The score calculation processing shown in FIG. 26 is executed by the score calculation unit 22 (see FIG. 1) of the sourcing support system 1. When the supplier evaluation execution button 2312 of the input/output screen 2300 (see FIG. 23) is pressed, the score calculation unit 22 (see FIG. 1) of the sourcing support system 1 executes the weight calculation processing shown in FIG. 26 as an example with the target part name and evaluation index weights Wi as inputs.

The sourcing support system 1 acquires all the supplier names associated with the target part name from the supplier information table 105 (see FIG. 10), and stores as names(candidate supplier name) of candidate supplier who can purchase the target part(step S 2601). Here, the sourcing support system 1 retrieves a record in which the sales part name 1002 of the supplier information table 105 is the target part name. The sourcing support system 1 stores the value of the supplier name 1001 of all the retrieved records as the candidate supplier name.

Next, the sourcing support system 1 starts loop processing for calculating the evaluation index score of supply capacity Si (step S 2602). The processing shown from the loop start step S 2602 to the loop end step S 2604 is repeated for each evaluation index of supply capacity (quality Q, cost C, deliver D, environment E). In step S 2602, the sourcing support system 1 selects one evaluation index from the unprocessed names of the evaluation indexes.

Next, the sourcing support system 1 calculates the evaluation index score Si of the supply capacity evaluation index selected in step 2602 based on the evaluation value of each of the evaluation index of supply capacity for each of the related parts and the target part, and stores the calculated evaluation index score Si of the supply capacity evaluation index in the score calculation history table 117 (step S 2603).

In step 2603, the sourcing support system 1 calculates all the evaluation value score Sij of the supply capacity and further calculates the evaluation index score Si as follows.

There are two types of evaluation values: numeric evaluation values and regulatory evaluation values. There are two types of evaluation values: numeric evaluation values and regulatory evaluation values. The numeric evaluation values for supply capacity include the defect rate for quality Q, the unit price for cost C, on-time delivery rate and delivery lead time for deliver D, and CO2 emissions for environment E. There are two regulatory evaluation values for supply capacity: the quality regulation fill-rate for quality Q and environment regulation fill-rate for environment E.

The sourcing support system 1 executes the following processes (2A) to (2C) to calculate the evaluation value score Sij of the numeric evaluation value.

(2A) The sourcing support system 1 acquires evaluation values associated with each of the candidate supplier names and the target part name from any of the quality information table 106 (see FIG. 11), the cost information table 108 (see FIG. 13), the due date information table 109 (see FIG. 14), and the environment information table 110 (see FIG. 15), and stores the candidate supplier name and the acquired evaluation value in association with each other.

(2B) The sourcing support system 1 calculates the ranking of the evaluation values of the candidate suppliers in all the candidate suppliers based on the evaluation values of all the acquired candidate suppliers, and further calculates the relative rank sr (%) of the evaluation values of the candidate suppliers. The sourcing support system 1 stores the candidate supplier name and the relative rank sr of the evaluation value of the candidate supplier name in association with each other. Here, the relative rank sr of the evaluation values is calculated in the order that the higher the relative rank sr is, the better the evaluation value of the candidate supplier is.

(2C) The sourcing support system 1 acquires the evaluation value score Sij associated with the relative rank sr of the evaluation value of the candidate supplier from the score calculation table 115 (see FIG. 20).

On the other hand, the sourcing support system 1 executes the following processes (3A) to (3C) to calculate the evaluation value score Sij of the regulatory evaluation value. There are two regulatory evaluation values: quality regulation fill-rate of cost C and environment regulation fill-rate of environment E.

(3A) The sourcing support system 1 obtains the number of required regulations from the quality standard information table 107 (see FIG. 12) or the environmental regulation information table 111 (see FIG. 16). Then, the sourcing support system 1 obtains the number of satisfied regulations from the quality information table 106 (see FIG. 11) or the environment information table 110 (see FIG. 15).

(3B) For sourcing support system 1, the value obtained by dividing the number of satisfied regulations by the number of required regulations (regulation fill-rate=number of satisfied regulations/number of required regulations) multiplied by 10 (number of satisfied regulations/number of required regulations×10) is calculated as the evaluation value score Sij of the regulatory evaluation item (Sij=number of satisfied regulations/number of required regulations×10). By multiplying by 10, the evaluation value score Sij of the regulatory evaluation value is set to be 0 or more and 10 or less. That is, the value of the evaluation value score Sij of the regulatory evaluation value is set to be 0 or more and 10 or less in the same manner as the value of the evaluation value score Sij of the numeric evaluation value.

And it can be considered generally that the number of satisfied regulations is more, the value of the number of satisfied regulations is better. because the greater number of satisfied regulations, the required regulations may be more adhered. The evaluation value score Sij of the regulatory evaluation value is 10 times the regulation fill-rate (regulation fill-rate=number of satisfied regulations/numbers of required regulations) obtained by dividing the number of satisfied regulations by the number of required regulations. Therefore, as with the score Sij of the evaluation value of the numeric evaluation value, the higher the value of the evaluation value score Sij of the regulatory evaluation value, the better the evaluation value score Sij of the regulatory evaluation value. That is, according to the score calculation table 115 (see FIG. 20), the better the regulatory evaluation value is, the higher the number of required regulations and the regulation fill-rate (regulation fill-rate=number of satisfied regulations/number of required regulations) obtained by dividing the number of satisfied regulations by the number of required regulations, and at the same time, the value of evaluation value score Sij of the regulatory evaluation item is set to be larger.

In this way, about the numeric evaluation value, the score calculation unit 22 of the sourcing support system 1 calculates the relative rank of the evaluation value of the numeric evaluation value in the candidate supplier group, for each of the candidate suppliers included in the candidate supplier group. Then, the score calculation unit 22 calculates the evaluation value score of the numeric evaluation value so that the evaluation value score of the numeric evaluation value increases in proportion to the height of the calculated relative rank. About the regulatory evaluation value, the score calculation unit 22 of sourcing support system 1 calculates the evaluation value score of the regulatory evaluation value for each candidate supplier included in the candidate supplier group. The score calculation unit 22 calculates the evaluation value score of the regulatory evaluation value so that the evaluation value score of the regulatory evaluation value increases in proportion to the ratio of the number of satisfied regulations to the number of required regulations.

FIG. 27 is a graph showing the relationship between the ranking of the evaluation values of the candidate suppliers and the evaluation value score Sij of the supply capacity. As described above, as shown in FIG. 27, the score calculation table 115 is set such that for both the numeric evaluation value and the regulatory evaluation value, the higher the relative rank sr (%) of the evaluation value is, the better the evaluation value is in all the candidate suppliers and the larger the value of the evaluation value score Sij is. The evaluation index score Si is the arithmetic mean of the evaluation value score Sij. Thus, the larger the evaluation value score Sij for both the numeric evaluation value and the regulatory evaluation value, the larger the evaluation index score Si.

The calculation method of the evaluation value score Sij of two types of evaluation values, i. e., numeric evaluation value and regulatory evaluation value, has been described above.

As described above, after the sourcing support system 1 calculates the evaluation value score Sij, the sourcing support system 1 calculates the arithmetic average of all the evaluation value score Sij as the evaluation index score Si for each evaluation index (see Equation 1c in FIG. 4).

A more specific calculation method of the evaluation index score Si described above will be described below. There are four evaluation indices of supply capacity: quality Q, cost C, deliver D, and environment E. For these four evaluation indexes, the sourcing support system 1 calculates an evaluation index score Si as described below.

There are two quality Q evaluation items: defect rate and quality regulation fill-rate. The evaluation value score SQ 1 of the defect rate is calculated as follows. The defect rate is the numeric evaluation value. (2A) For each candidate supplier, the sourcing support system 1 searches the quality information table 106 (see FIG. 11) for a record in which the supplier name 1101 is the candidate supplier name and the sales part 1102 is the target part name. The sourcing support system 1 sets the value of the defect rate 1103a of the retrieved record as the value of the defect rate. The sourcing support system 1 stores the value of the defect rate and the candidate supplier name in association with each other.

Next, (2B) the sourcing support system 1 calculates the ranking of the defect rates of the candidate suppliers in all the candidate suppliers, based on the acquired value(evaluation values) of the defect rates in all the candidate suppliers. Further, for each candidate supplier, the sourcing support system 1 calculates a relative rank sr (%) of the defect rate (evaluation value) by dividing he ranking of the defect rates of the candidate suppliers by the number of candidate suppliers (the number of candidate supplier names acquired by the sourcing support system 1 in step 2601). The lower the defect rate (%), the better. Therefore, the sourcing support system 1 calculates the rank of the defect rate (evaluation value) of the candidate supplier as the defect rate (evaluation value) is lower, the rank of the defect rate of the candidate supplier becomes higher. Therefore, as relative rank sr (%) of the defect rate (evaluation value) is higher, the defect rate (evaluation value) is lower and the defect rate is better.

Next, the (2C) sourcing support system 1 acquires an evaluation value score Sij associated with a relative rank sr of the defect rate (evaluation value) of the candidate supplier from the score calculation table 115 (see FIG. 20), for each candidate supplier, and sets the acquired evaluation value score as an evaluation value score SQ 1.

In addition, the sourcing support system 1 calculates the evaluation value score SQ 2 of the quality regulation fill-rate among the evaluation items of the quality Q, as follows. Quality regulation fill-rate is a regulatory evaluation value. (3A) The sourcing support system 1 obtains the number of required regulations from the quality standard information table 107 (see FIG. 12). That is, the sourcing support system 1 retrieves the record in which the part name 1201 is the target part name from the quality standard information table 107 (see FIG. 12), and calculates the number of required quality standards names of the required quality standards name 1202 of the retrieved record as the number of required standards.

Next, the sourcing support system 1 obtains the number of satisfied regulations that is an evaluation value, from the quality information table 106 (see FIG. 11). That is, for each candidate supplier, the sourcing support system 1 searches the quality information table 106 (see FIG. 11) for a record in which the supplier name 1101 is the candidate supplier name and the sales part 1102 is the target part name. The sourcing support system 1 sets the value of the number of satisfied standard 1103b of the retrieved record as the value of the number of satisfied regulations.

Next, (3B) the sourcing support system 1 calculates a value obtained by dividing the number of satisfied regulations by the number of required regulations and then multiplying the result by 10 (number of satisfied regulations/number of required regulations×10) as the evaluation value score SQ 2 of the quality regulation fill-rate (SQ 2=number of satisfied regulations/number of required regulations×10), for each candidate supplier.

As described above, the sourcing support system 1 calculates the evaluation value score SQ 1 and SQ 2 of all evaluation items (defect rate, quality regulation fill-rate) of the quality Q of the candidate suppliers. Then, the sourcing support system 1 calculates the arithmetic mean of the evaluation value score SQ 1 and SQ 2 of all evaluation items (defect rate, quality regulation fill-rate) of quality Q as the evaluation index score SQ of quality Q (SQ=(SQ 1+SQ 2)/2).

The evaluation value of cost C is only unit price. The lower the unit price is, the better the evaluation value is. The sourcing support system 1 calculate the evaluation value score SC 1 of the cost C using the cost information table 108 (see FIG. 13) and the score calculation table 115 (see FIG. 20) in the same manner as calculating the evaluation value score SQ 1 of the defect rate of the quality Q. Then, the sourcing support system 1 sets the value of the calculated evaluation value score SC 1 of the cost C as the value of evaluation index score SC of the cost C.

The deliver D evaluation item is a two numeric evaluation item: the on-time delivery rate (%) and the delivery lead time (days). s The sourcing support system 1 calculates the evaluation value score SD 1 of the on-time delivery rate and the evaluation value score SD 2 of the delivery lead time using the due date information table 109 (see FIG. 14) and the score calculation table 115 (see FIG. 20) in the same manner as calculating the evaluation value score SQ 1 of the defect rate in quality Q described above. Then, the sourcing support system 1 calculates the arithmetic mean of the evaluation value score SD 1 and SD 2 of all deliver D evaluation items (on-time delivery rate, delivery lead time) as the evaluation index score SD of deliver D (SD=(SD 1+SD 2)/2).

There are two environment E evaluation values: environmental regulation fill-rate and CO2 emissions. The environmental regulation fill-rate is a regulatory evaluation value. On the other hand, CO2 emissions is a numeric evaluation values. The sourcing support system 1 calculates the evaluation value score SE 1 of the environment regulation fill-rate using the environment information table 110 (see FIG. 15) and the environmental regulation information table 111 (see FIG. 16) in the same manner as calculating the evaluation value score SQ 2 of the quality regulation fill-rate of the quality, described above.

The sourcing support system 1 calculates the evaluation value score SE 2 of the CO2 emissions using the environment information table 110 (see FIG. 14) and the score calculation table 115 (see FIG. 20) in the same manner as calculating the evaluation value score SQ 1 of the defect rate of quality Q described above. Then, the sourcing support system 1 calculates the arithmetic mean of the evaluation value score SE 1 and SE 2 of all evaluation items (environment regulation fill-rate, CO2 emissions) of the environment E as the evaluation index score SE (SE=(SE 1+SE 2)/2) of the environment E.

Next, the sourcing support system 1 judges whether the processing is completed for all the evaluation indexes (quality Q, cost C, deliver D, environment E) of the supply capacity (step S 2604). If the sourcing support system 1 judges that the processing has not been completed for all the evaluation indexes of the supply capacity, the sourcing support system 1 returns to the step S 2602 to continue the processing. On the other hand, when the sourcing support system 1 judges that the processing has been completed for all the evaluation indexes of the supply capacity, the sourcing support system 1 proceeds to step S 2605.

Next, the sourcing support system 1 calculates the supply capacity score Sa of each candidate supplier, and stores the calculated supply capacity score Sa and the candidate supplier name, in association with each other in the score calculation history table 117 (step 2605). Here, the sourcing support system 1 calculates the sum (Σ Wi×Si) of the products of the evaluation index weight Wi and the evaluation index score Si to all the evaluation indexes (quality Q, cost C, deliver D, environment E) of the supply capacity, as the supply capacity score Sa (supply capacity score Sa=Σ Wi×Si).

Next, the sourcing support system 1 starts loop processing for calculating an evaluation index score Si of soundness (step S 2606). The processing shown between the loop start step 2606 and the loop end step 2608 is repeated for each evaluation index of soundness (finance F, social risk S, governance G). In step 2606, the sourcing support system 1 selects one name of evaluation index of soundness from the names of the unprocessed evaluation index of soundness.

Next, the sourcing support system 1 calculates evaluation value score Sij of the evaluation index of soundness selected in step 2606 for each candidate supplier, calculates evaluation index score Si of the evaluation index of soundness based on the calculated evaluation value score Sij, and stores the calculated evaluation index score Si and the candidate supplier name in the score calculation table 115 in association with each other (step S 2607).

In step 2607, the sourcing support system 1 executes the similar processing as in step S 2602 to calculate all of the evaluation values score Sij of the evaluation index of soundness, and further calculates the evaluation index score Si.

There are three evaluation indexes of soundness: financeF, social risk S, and governance G. For these three evaluation indexes, the sourcing support system 1 calculates an evaluation index score Si as described below. The numeric evaluation values include capital ratio, current ratio, and quick assets ratio for the finance F, and number of scandals for governance G. The evaluation value of the standard includes labor environment regulation fill-rate of social risk S.

There are three evaluation items of finance F: capital ratio, current ratio, and quick assets ratio. The sourcing support system 1 calculates the evaluation value score SF 1 of the capital ratio using the capital ratio 1702a of the financial information table 112 (see FIG. 17) and the score calculation table 115 (see FIG. 20) in the similar manner as calculating the evaluation value score SQ 1 of the defect rate of quality, described above. The sourcing support system 1 calculates the evaluation value score SF 2 of the current ratio using the current ratio 1702b of the financial information table 112 (see FIG. 17) and the score calculation table 115 (see FIG. 20) in the similar manner as calculating the evaluation value score SQ 1 of the defect rate of the quality Q described above. Then, the sourcing support system 1 calculates the evaluation value score SF 2 of the quick assets ratio using the quick assets ratio 1702c of the financial information table 112 (see FIG. 17) and the score calculation table 115 (see FIG. 20) in the similar manner as calculating the evaluation value score SQ 1 of the defect rate of the quality Q described above.

In addition, the sourcing support system 1 calculates the arithmetic mean of the evaluation value score SF 1, SF 2, and SF 3 of all finance F evaluation items (capital ratio, current ratio, and quick assets ratio) as the evaluation index score SF (SF=(SF 1+SF 2+SF 3)/3) of the finance F.

The evaluation item for social risk S is only the labor environment regulation fill-rate. The minimum environmental regulation fill-rate is the regulatory evaluation value. The sourcing support system 1 calculates the evaluation value score SS 1 of the labor environment regulation fill-rate using the social risk information table 113 (see FIG. 18) in the similar manner as calculating the evaluation value score SQ 2 of the quality regulation fill-rate of the quality Q described above. Here, There are different configurations between the quality information table 106 (see FIG. 11) used for the calculation of the evaluation value score SQ 2 of the quality regulation fill-rate, and the social risk information table 113 (see FIG. 18) used for the calculation of the evaluation value score SS 1 of the labor environment regulation fill-rate. Therefore, the calculation method of the evaluation value score SS 1 of the labor environment regulation fill-rate differs from the calculation method of the evaluation value score SQ 2 of the quality regulation fill-rate in the following points.

In the calculation method of the evaluation value score SQ 2 of the quality regulation fill-rate, the number of satisfied standard is obtained from the number of satisfied standard 1103 b of the quality information table 106 (see FIG. 11), and the number of required quality standards is calculated from the quality standard information table 107 (see FIG. 12). Then, the value obtained by dividing the number of satisfied regulations by the number of required regulations and multiplied by 10(number of satisfied regulations/number of required regulations×10) is calculated as the evaluation value score SQ 2 of the quality regulation fill-rate (SQ 2=number of satisfied regulations/number of required regulations×10).

On the other hand, in the calculation method of the evaluation value score SS 1 of the labor environment regulation fill-rate, the number of required standards is obtained from the number of required standards 1803 in the social risk information table 113 (see FIG. 18), and the number of satisfied standard is obtained by subtracting the number of unsatisfied standard 1802 from the number of required standards 1803 in the social risk information table 113 (see FIG. 18) (number of satisfied standard=number of required standards 1802−number of unsatisfied standard 1802). Then, the sourcing support system 1 calculates the value obtained by dividing the number of satisfied regulations by the number of required regulations and multiplied by 10(number of satisfied regulations/number of required regulations×10) as the evaluation value score SE 1 of the labor environment regulation fill-rate (SE 1=number of satisfied regulations/number of required regulations×10). Furthermore, the calculated evaluation value score SE 1 of the labor environment regulation fill-rate is used as the evaluation index score SS of social risk S (SS=SE 1=number of satisfied regulations/number of required regulations×10).

The governance G evaluation item is only the number of scandals. Number of scandals is the numeric evaluation value. The sourcing support system 1 calculates the evaluation value score SG 1 of the number of scandal using the number of scandals 1902 in the governance information table 114 (see FIG. 19) and the score calculation table 115 (see FIG. 20) in the similar manner as calculating the evaluation value score SQ 1 of the defect rate of the quality Q described above. Then, the sourcing support system 1 sets the calculated evaluation value score SG 1 of the number of scandals as the evaluation index score SG (SG=SG 1) of the governance G.

Next, the sourcing support system 1 judges whether the processing has been completed for all the evaluation indexes (finance F, social risk S, governance G) of the soundness (step S 2608). If the sourcing support system 1 judges that the processing has not been completed for all the evaluation indexes of the soundness, the sourcing support system 1 returns to step S 2606 to continue the processing. On the other hand, when the sourcing support system 1 judges that the processing has been completed for all the evaluation indexes of the soundness, the sourcing support system 1 proceeds to step S 2609.

Next, the sourcing support system 1 calculates the soundness score Sh of each candidate supplier, and stores the calculated soundness score Sh and the candidate supplier name, in association with each other in the score calculation history table 117 (step 2609). Here, the sourcing support system 1 calculates the sum of the evaluation index score Si of the evaluation index of soundness (Σ Si=SF+SS+SG) as a soundness score Sh (Sh=Σ Si=SF+SS+SG), stores the calculated soundness score Sh, candidate supplier name, and the calculation date 2212 in association with each other in the score calculation history table 117 (see FIG. 22), and terminates the processing.

As described above, in the sourcing support system 1, the score calculation unit 22 calculates the calculation results such as the supply capacity score Sa and the soundness score Sh for each candidate supplier, the score calculation unit 22 outputs the calculation results to the output device 15 or the network I/F 16, and displays the calculation results in the supplier evaluation result display column 2320 of the input/output screen (see FIG. 23). That is, as described above, in the supplier evaluation result display column 2320 of the input/output screen 2300 of FIG. 23, information on the optimal candidate supplier having the highest supply capacity score Sa among the candidate suppliers having a soundness score Sa greater than the soundness threshold input in the soundness threshold input column 2320 is displayed in the supplier evaluation result display column 2302.

<Evaluation Information Generation Process, FIG. 28>

When any one of the soundness sufficient suppliers table display button 2325, the soundness priority supplier table display button 2326, and the supply capacity priority supplier table display button 2329 of the input/output screen 2300 shown in FIG. 23 is pressed by the user's operation, the evaluation information generation unit 23 outputs supplier evaluation information (see FIG. 28) in which the candidate supplier name (supplier specifying information), the supply capacity score Sa, and the soundness score Sh are associated, to the output device 15, and causes the output device 15 to present the supplier evaluation information. As described above, the supplier evaluation information includes a soundness sufficient suppliers table, a soundness score priority candidate supplier table, and a supply capacity score priority candidate supplier table. The evaluation information generating process generate the soundness sufficient suppliers table, the soundness score priority candidate supplier table, and the supply capacity score priority candidate supplier table and output them to the output device 15 or user terminal 2 via the network I/F 16.

When the user presses the soundness sufficient suppliers table display button 2325 of the input/output screen 2300 shown in FIG. 23, the evaluation information generation unit 23 generates a soundness sufficient suppliers table in the evaluation information generation process, and outputs the soundness sufficient suppliers table to the output device 15 or the network I/F 16. Thus, the evaluation information generation unit 23 causes the output device 15 or the user terminal 2 to present the soundness sufficient suppliers table. As described below, as shown in FIG. 28, the soundness sufficient suppliers table is the information in which the supply capacity score Sa is arranged in descending order with respect to the soundness sufficient candidate supplier whose soundness score is bigger than a predetermined soundness threshold among the candidate suppliers, and the soundness sufficient candidate supplier name (sound supplier specifying information) capable of specifying the soundness sufficient candidate supplier, the supply capacity score Sa, and the soundness score Sh are associated with each other.

FIG. 28 is an explanatory diagram showing an example of a FSG sufficient supplier display screen showing a soundness sufficient suppliers table. The FSG sufficient supplier display screen 2800 shown in FIG. 28 has the part name 2801, the supplier name 2802, the quality Q evaluation index score column 2803, the cost C evaluation index score column 2804, the deliver D evaluation index score column 2805, the environment E evaluation index score column 2806, the finance F evaluation index score column 2807, the social risk S evaluation index score column 2808, the governance G evaluation index score column 2809, the supply capacity score column 2810, and the soundness score column 2811.

The part name 2801 is the name of the target part. The supplier name 2802 is a column of the names of the candidate suppliers.

As described above, the soundness score priority candidate supplier table is the information in which all the candidate suppliers are arranged in descending order of the soundness score Sa, and the supply capacity score Sa, the soundness score Sh, and the candidate supplier name (supplier specifying information) are associated with each other. The configuration of the soundness score priority candidate supplier table is similar to that of the soundness sufficient suppliers table described with reference to FIG. 28. Therefore, illustration and description of the soundness score priority candidate supplier table are omitted.

The supply capacity score priority candidate supplier table is the information in which all the candidate suppliers are arranged in descending order of the supply capacity score Sh, and the supply capacity score Sa, the soundness score Sh, and the candidate supplier name (supplier specifying information) are associated with each other. The configuration of the supply capacity score priority candidate supplier table is similar to that of the soundness sufficient suppliers table described with reference to FIG. 28. Therefore, illustration and description of the supply capacity score priority candidate supplier table are omitted.

### Effects of the Invention

Thus, in the embodiment, the sourcing support system 1 facilitates the user to selection of suitable parts supplier of the part by the following steps 1 to 3.

1. The sourcing support system 1 calculates the supply capacity score Sa and the soundness score Sh for each candidate supplier who can purchase the target part. So, the sourcing support system 1 facilitates the user to compare the candidate suppliers with reference to the supply capacity score Sa and the soundness score Sh. Thus, the sourcing support system 1 facilitates the selection of a suitable supplier for the part.

2, supply capacity score Sa is the sum of the products of the evaluation index weight Wi and the evaluation index score Si for the evaluation index of supply capacity (supply capacity score Sa=Σ (evaluation index weight Wi×evaluation index score Si)). Here, the supply capacity score Sa is calculated by weighting the evaluation index score Si. This allows the supply capacity score Sa to properly represent the supply capacity of the candidate supplier.

3. The sourcing support system 1 calculates the evaluation index weight Wi using the current evaluation value for the evaluation index of supply capacity for the target part and related parts. Therefore, the sourcing support system 1 can calculate the evaluation index weight of supply capacity Wi in consideration of the supply status of the related parts group. Thus, the sourcing support system 1 can appropriately calculate the evaluation index weight Wi of supply capacity. Consequently, the sourcing support system 1 can calculate appropriate supply capacity score S Sa.

In addition, the sourcing support system 1 can suppress global warming by reducing the energy required to select the supplier of the part and the amount of carbon dioxide emissions generated.

In addition, the sourcing support system 1 not only evaluates the supplier of the part by the supplier's evaluation index of supply capacity (quality Q, cost C, deliver D, environment E), but also evaluates the supplier of the part by the supplier's evaluation index of soundness (finance F, social risk S, governance G). This makes it easy to select suppliers that are suitable not only for supply capacity but also for soundness. The sourcing support system 1 can calculate the supply capacity score Sa and the soundness score Sh of the candidate supplier after acquiring the information collected by the information management device 3 in accordance with the change of the social situation, from the information management device 3. As a result, the sourcing support system 1 makes it easy to supply the parts in response to changes in social conditions and production systems.

The evaluation index of supply capacity includes four evaluation indexes: quality, cost, deliver, and environment. This enables the sourcing support system 1 to appropriately calculate the supply capacity score Sa.

The evaluation index of soundness includes three evaluation indexes: finance, social risk, and governance. This enables the sourcing support system 1 to appropriately calculate the soundness score Sh.

In the sourcing support system 1, the weight calculation unit 21 calculates the relative rank wr in the related parts group of the current evaluation value of each evaluation index of supply capacity to the target part, and calculates the evaluation index of each evaluation index of supply capacity based on the calculated relative rank wr. In the sourcing support system 1, since the value of the evaluation index weight Wi is calculated according to the relative rank wr of the current evaluation value Si, it is possible to suppress the change in the value of the evaluation index weight Wi due to the difference in the current evaluation value Si unit (for example, the difference in the unit of 1,000 yen or 1,000,000 yen). Therefore, the sourcing support system 1 can appropriately calculate the evaluation index weight Wi.

In the sourcing support system 1, the weight calculation unit 21 calculates the evaluation index weight Wi such that the value of the evaluation index weight Wi increases as the relative rank wr of the current evaluation value decreases. As a result, in the sourcing support system 1, the evaluation index weight Wi is calculated so that the value of the evaluation index weight Wi increases for the evaluation index with a low relative rank wr of the current evaluation value, which is considered to require special attention because the relative rank wr of the current evaluation value is low. Therefore, in the calculation of the supply capacity score Sa, the sourcing support system 1 increases the evaluation index weight Wi for the evaluation index that requires special attention, thereby increasing the contribution of the evaluation index score Si to the supply capacity score Sa. Thus, the sourcing support system 1 can appropriately calculate the value of the evaluation index weight Wi.

The evaluation index of supply capacity or evaluation index of soundness includes a composite evaluation index that uses multiple evaluation values to calculate an evaluation index score. quality Q, deliver D, environment E, and finance F are composite evaluation indexes. In the sourcing support system 1, the composite evaluation index can be used to calculate the evaluation index score with multiple evaluation values for one evaluation index. Thus, the sourcing support system 1 can calculate a more appropriate evaluation index score.

The evaluation index of supply capacity includes a composite evaluation index that uses multiple evaluation values to calculate an evaluation index score. quality Q, deliver D, and environment E are composite evaluation indexes for evaluation index of supply capacity. In the sourcing support system 1, the score calculation unit 22 calculates the average of the evaluation value score Sij of the plurality of evaluation values for the composite evaluation index as the evaluation index score Si of the composite evaluation index. Here, the sourcing support system 1 calculates the evaluation index score Si based on the evaluation value score Sij of the plurality of evaluation values instead of one evaluation value score Sij. Thus, the sourcing support system 1 can calculate an appropriate supply capacity score Sa.

The evaluation index of soundness includes the composite evaluation index, which uses multiple evaluation values to calculate the evaluation index score Si. The finance F is the composite evaluation index of the soundness evaluation index. In the sourcing support system 1, the score calculation unit 22 calculates the average of the evaluation value score Sij of the plurality of evaluation values for the composite evaluation index as the evaluation index score Si of the composite evaluation index. Here, the sourcing support system 1 calculates the evaluation index score Si based on the evaluation value score Sij of the plurality of evaluation values instead of one evaluation value score Sij. Thus, the sourcing support system 1 can calculate a more appropriate soundness score Sh.

The sourcing support system 1 can calculate evaluation values not only for numeric evaluation values but also for regulatory evaluation values. The sourcing support system 1 uses not only the numeric evaluation value but also the numeric evaluation value and the regulatory evaluation value to calculate the supply capacity score Sa or the soundness score Sh. Thus, the sourcing support system 1 can calculate an appropriate supply capacity score Sa and an appropriate soundness score Sh.

In the sourcing support system 1, an evaluation information generation unit 23 outputs the supplier evaluation information in which a candidate supplier name (supplier specifying information), a supply capacity score Sa, and a soundness score Sh are associated with each other. Thus, the user can easily compare the supply capacity score Sa and the soundness score Sh among the candidate suppliers. Therefore, in the sourcing support system 1, the evaluation information generation unit 23 outputs the supplier evaluation information, so that the user can easily select a suitable supplier of the part.

In a sourcing support system 1, the evaluation information generation unit 23 arranges, among candidate suppliers, soundness sufficient candidate suppliers having a soundness score Sh greater than a predetermined soundness threshold in descending order of supply capacity score Sa, and calculate a soundness sufficient suppliers table in which supply capacity score Sa, soundness score Sh, and soundness sufficient candidate supplier names (sound supplier specifying information) are associated. And the evaluation information generation unit 23 out puts the soundness sufficient suppliers table. Thus, the user can easily compare the supply capacity score Sa and the soundness score Sh among the candidate suppliers which are considered to have sufficient soundness because the soundness score Sh is larger than the soundness threshold. Thus, the sourcing support system 1 facilitates the user to select a suitable supplier for the part.

The sourcing support system 1 calculates two score S of supply capacity score Sa and soundness score Sh from the evaluation values of various evaluation indexes, and presents them to the user. Therefore, the user can evaluate the candidate supplier who can purchase the target part by considering the various evaluation items of the various evaluation indexes, by evaluating the candidate supplier using only two values of the supply capacity score Sa and the soundness score Sh presented from the sourcing support system 1. This makes it easy for the user to select a suitable supplier.

For example, conventionally, there is a case where a person in charge of manufacturing who performs design, manufacturing, or the like evaluates a supplier with only supply capacity, selects a supplier candidate for purchasing a target part, and the person in charge of purchasing finally decides whether or not to purchase the target part from the supplier candidate selected by the person in charge of manufacturing in this way. In this case, by using the sourcing support system 1, the manufacturing staff can easily select the supplier candidate to purchase the target part after evaluating not only the supply capacity but also the soundness of the supplier. The supplier candidates selected by the manufacturing staff to purchase the target part were selected based on not only the supply capacity but also the soundness, so they were selected more appropriately. Because the buyer decides whether or not to purchase the target part from a better selected supplier, the buyer can more easily decide whether or not to purchase from a supplier. In addition, it becomes easy to obtain an agreement between the person in charge of manufacturing and the person in charge of purchasing as to which supplier should be the supplier who purchases the target part. This allows both manufacturing and purchasing personnel to more easily decide which supplier to purchase the target part from.

Manufacturing and purchasing personnel can also use the supply capacity Sa score and soundness score Sh calculated by the sourcing support system 1 to select a number of supplies, examine the status of the selected suppliers in more detail, and make a final decision on which supplier to purchase the target part. When the supplier who purchases the target part is going to be determine, the number of suppliers to be examined in detail can be reduced by selecting several supplies using the calculated supply capacity Sa score and soundness score Sh. By reducing the number of suppliers to be scrutinized, manufacturing and purchasing personnel can more easily examine the status of suppliers in terms other than supply capacity Sa score and soundness score Sh. Thus, the sourcing support system 1 makes it easier for the user to examine the supplier's situation in more detail in terms of other than supply capacity Sa score and soundness score Sh.

### Modification 1

In the sourcing support system 1 of the embodiment described above, the weight calculation unit 21 calculates the arithmetic average of the evaluation value weight Wij as the evaluation index weight Wi in the weight calculation processing (step 2404 of FIG. 24).

The score calculation unit 22 calculates the arithmetic mean of the evaluation value score Sij as the evaluation index score Si in the score calculation processing (steps S 2603 and S 2607 in FIG. 25). The score calculation unit 22 calculates the supply capacity score Sa and the soundness score Sh using the evaluation index weight Wi and the evaluation index score Si calculated as described above.

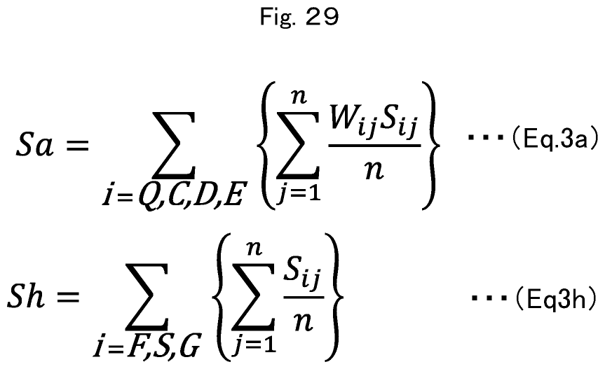

FIG. 29 is an explanatory diagram for explaining a method of calculating the supply capacity score Sa and the soundness score Sh of the modification. As shown in Equations 3a and 3h of FIG. 29, in this modification, instead of calculating the arithmetic average of the evaluation value weight Wij and the arithmetic average of the evaluation value score Sij, the supply capacity score Sa is calculated by the sum of the evaluation value weight Wij and the evaluation value score Sij, and the soundness score Sh is calculated by the sum of the evaluation value score Sij. In this modification, “evaluation value weight Wij” is referred to as “evaluation index weight” as well as “evaluation index weight” of each evaluation index of supply capacity (quality Q, cost C, deliver D, environment E). In this modification, “evaluation value score Sij” is referred to not only as “evaluation value score” for evaluation index (quality Q, cost C, deliver D, environment E, financeF, social riskS, governanceG), but also as “evaluation index score”.

As shown in Equation 3h of FIG. 29 and Equations 1c and 2 of FIG. 4, the soundness score Sh representing the soundness of the candidate supplier has the same value in the soundness score Sh of the embodiment and the soundness score Sh of the modification. On the other hand, as shown in Equation 3a of FIG. 29 and Equations 1, 1a, 1b, and 1c of FIG. 4, the soundness score Sa representing the supply capacity of the candidate supplier is different between the supply capacity score Sa of the embodiment and the supply capacity score Sa of the modification. In the process of calculating the supply capacity score Sa of the modification, the arithmetic mean of the evaluation value weight Wij and the arithmetic mean of the evaluation value score Sij are not calculated. Therefore, the sourcing support system 1 of the modification example can calculate the supply capacity score Sa that more largely reflects the characteristics of the evaluation item than the sourcing support system 1 of the embodiment. Thus, when it is desired to evaluate and compare candidate suppliers with a supply capacity score Sa that more largely reflects the characteristics of the evaluation item, the sourcing support system 1 of the modification can calculate a suitable supply capacity score Sa and present it to the user. Furthermore, the sourcing support system 1 of the modified example facilitates the user to select a suitable supplier of the part.

What is claimed is:

1. A sourcing support system calculating a value for evaluating a supplier of parts, the sourcing support system comprising:
a weight calculation unit configured to
calculate the name of the related parts group related to the target part, when a target part specifying information that can specify the target part is input;
calculate the name of the related parts group related to the target part;
calculate the evaluation index weights of each of the evaluation indexes of the supply capacity, based on the current evaluation values of each evaluation index of supply capacity for the supplying supplier that has supplied each of the target part and the related part included in the related parts group; and
a score calculation unit configured to
calculate a name of a candidate supplier who can purchase the target part;
calculate the evaluation index score of each of the evaluation index of supply capacity and the evaluation index score of each of the evaluation index of soundness, for each of the calculated names of the candidate suppliers;
calculate the sum of the products of the evaluation index weight and the evaluation index score, with respect to the evaluation index of supply capacity as a supply capacity score;
calculate the sum of the evaluation index score S of each of the evaluation index of soundness as the soundness score.

2. The sourcing support system according to claim 1, wherein:
the evaluation index of supply capacity includes four evaluation indexes: quality, cost, deliver, and environment.

3. The sourcing support system according to claim 1, wherein:
the evaluation index of soundness includes three evaluation indexes: finance, social risk, and governance.

4. The sourcing support system according to claim 1, wherein:
the weight calculation unit calculates the relative rank in the related parts group of the current evaluation value of each of the evaluation indexes of supply capacity for the target part, and
calculates the evaluation index weight of each of the evaluation indexes of supply capacity, based on the calculated relative rank.

5. The sourcing support system according to claim 1, wherein: the weight calculation unit calculates the evaluation index weight so that the value of the evaluation index weight increases as the relative rank decreases.

6. The sourcing support system according to claim 1, wherein: the evaluation index of supply capacity or the evaluation index of soundness includes a composite evaluation index for calculating the evaluation index score using a plurality of evaluation values.

7. The sourcing support system according to claim 6, wherein: the evaluation index of supply capacity includes a composite evaluation index for calculating the evaluation index score using a plurality of evaluation values;
the weight calculation unit
calculates the evaluation value weight of each of the plurality of evaluation values to the composite evaluation index, and
calculates the arithmetic average value of the calculated evaluation value weight of the plurality of evaluation values as the evaluation index weight of the composite evaluation index; and the score calculation unit
calculates the evaluation value score of each of the plurality of evaluation values to the composite evaluation index, and
calculates the arithmetic average value of the calculated evaluation value score of the plurality of evaluation values as the evaluation index score of the composite evaluation index.

8. The sourcing support system according to claim 6, wherein: the evaluation index of soundness includes a composite evaluation index for calculating the evaluation index score using a plurality of evaluation values;
the score calculation unit
calculates the evaluation value score of each of the plurality of evaluation values to the composite evaluation index, and
calculates the arithmetic average value of the calculated evaluation value score of the plurality of evaluation values as the evaluation index score of the composite evaluation index.

9. The sourcing support system according to claim 1, wherein: the evaluation value includes two types of evaluation values: numeric evaluation values and regulatory evaluation values;
the score calculation unit
for each of the candidate suppliers included in the candidate supplier group,
calculates the relative rank of the numeric evaluation value in the candidate supplier to the numeric evaluation value, and
calculates the evaluation value score of the numeric evaluation value so that the evaluation value score of the numeric evaluation increases in proportion to the height of the calculated relative rank;
calculates the evaluation value score of the regulatory evaluation value so that the value increases in proportion to the height of the ratio of the number of required regulation to the number of satisfied regulations which is number of the regulation already satisfied by the candidate supplier; and
calculates the evaluation index score using the calculated evaluation value score.

10. The sourcing support system according to claim 1, wherein: the sourcing support system further comprises an evaluation information generation unit;
the evaluation information generation unit configured to outputs the supplier evaluation information in which the supplier specifying information, the supply capacity score, and the soundness score are associated with each other.

11. The sourcing support system according to claim 1, wherein: the evaluation information generation unit outputs a soundness sufficient suppliers table in which, among the candidate suppliers, soundness sufficient candidate suppliers having a soundness score higher than a predetermined soundness threshold are arranged in descending order of the supply capacity score, and the supply capacity score, the soundness score, and sound supplier specifying information that can specify the soundness sufficient candidate suppliers are associated with each other.

12. a sourcing support method of a sourcing support system wherein the sourcing support system comprising a processor, the method comprising: by the processor,
a weight calculation processing configured to
calculate the name of the related parts group related to the target part, when a target part specifying information that can specify the target part is input;
calculate the name of the related parts group related to the target part;
calculate the evaluation index weights of each of the evaluation indexes of the supply capacity, based on the current evaluation values of each evaluation index of supply capacity for the supplying supplier that has supplied each of the target part and the related part included in the related parts group; and
a score calculation processing configured to
calculate a name of a candidate supplier who can purchase the target part;
calculate the evaluation index score of each of the evaluation index of supply capacity and the evaluation index score of each of the evaluation index of soundness, for each of the calculated names of the candidate suppliers;
calculate the sum of the products of the evaluation index weight and the evaluation index score, with respect to the evaluation index of supply capacity as a supply capacity score;
calculate the sum of the evaluation index score S of each of the evaluation index of soundness as the soundness score.
